(19) United States
(12) Patent Application Publication
(10) Pub. No.: US 2023/0155755 A1
(43) Pub. Date: May 18, 2023

(54) TECHNIQUE FOR CONFIGURING PREAMBLE IN WIRELESS COMMUNICATION SYSTEM

(71) Applicant: LG ELECTRONICS INC., Seoul (KR)

(72) Inventors: Dongguk Lim, Seoul (KR); Jinyoung Chun, Seoul (KR); Jinsoo Choi, Seoul (KR); Eunsung Park, Seoul (KR)

(21) Appl. No.: 17/915,366

(22) PCT Filed: Mar. 31, 2021
(86) PCT No.: PCT/KR2021/004008

§ 371 Date: Sep. 28, 2022

(30) Foreign Application Priority Data
Mar. 31, 2020 (KR) 10-2020-0039237
Apr. 2, 2020 (KR) 10-2020-0040453
Apr. 7, 2020 (NO) 10-2020-0042350
Apr. 7, 2020 (NO) 10-2020-0042357

(51) Int. Cl. H04L 5/00; H04W 72/0453

(52) U.S. Cl. CPC H04L 5/0044; H04W 72/0453; H04W 84/12

(57) ABSTRACT

According to various embodiments, a receiving STA can receive a physical layer protocol data unit (PPDU) including a first signal field. The first signal field may include a plurality of content channels. The plurality of content channels can be configured on the basis of a first bandwidth. A first content channel and a second content channel, from among the plurality of content channels, can be configured in the frequency range of the first bandwidth.

### BACKGROUND

### Technical Field

This specification relates to a technique for configuring a preamble in a wireless LAN system, and more particularly, to a method for configuring a signal field in a preamble in a wireless LAN system and an apparatus supporting the same.

### Related Art

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

### SUMMARY

### Technical Objects

In the EHT standard, in order to support high throughput and high data rate, a wide bandwidth (for example, 160/320 MHz), 16 streams, and/or multi-link (or multi-band) operation may be used.

In the EHT standard, a wide bandwidth (for example, 160/240/320 MHz) may be used for high throughput. In addition, in order to efficiently use bandwidth, preamble puncturing and multiple RU transmission may be used.

In the EHT standard, for load balancing for single field and data, parsing the STA with an 80 MHz segment to transmit and receive signals is considered. Therefore, when transmitting the EHT MU PPDU using a wide bandwidth (for example, 160/240/320 MHz), the EHT SIG configuration and transmission method in consideration of preamble puncturing/multiple RU allocation, and 80 MHz segment parsing can be proposed.

### Technical Solutions

According to various embodiments, a receiving STA may receive a physical layer protocol data unit (PPDU) including a first signal field, wherein the first signal field includes a plurality of content channels, wherein the plurality of content channels are configured based on a first bandwidth, wherein a first content channel and a second content channel among the plurality of content channels are configured within a frequency range of the first bandwidth, wherein the first content channel and the second content channel are configured based on a second bandwidth, respectively, and wherein the first content channel and the second content channel are repeated in units of a third bandwidth within the frequency range of the first bandwidth; and decode the PPDU based on the first signal field.

### Technical Effects

According to various embodiments, the signal field of the EHT PPDU (for example, EHT-SIG) may be duplicated and transmitted in units of a specific bandwidth. Therefore, there is an effect that the receiving STA can check information included in the signal field even if only a specific bandwidth is checked, without checking the signal field of the entire bandwidth of the EHT PPDU.

According to various embodiments, the EHT-SIG may be configured differently in units of 160 MHz. Therefore, there is an effect that the overhead of EHT-SIG is reduced to ½ when MU transmission using a wide bandwidth. Also, 80 MHz segment operation by subchannel selective transmission (SST) can be supported without additional signaling.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates an example of a PPDU used in an IEEE standard.

FIG. 4 illustrates a layout of resource units (RUs) used in a band of 20 MHz.

FIG. 5 illustrates a layout of RUs used in a band of 40 MHz.

FIG. 6 illustrates a layout of RUs used in a band of 80 MHz.

FIG. 7 illustrates a structure of an HE-SIG-B field.

FIG. 8 illustrates an example in which a plurality of user STAs are allocated to the same RU through a MU-MIMO scheme.

FIG. 9 illustrates an operation based on UL-MU.

FIG. 10 illustrates an example of a channel used/supported/defined within a 2.4 GHz band.

FIG. 11 illustrates an example of a channel used/supported/defined within a 5 GHz band.

FIG. 12 illustrates an example of a channel used/supported/defined within a 6 GHz band.

FIG. 13 illustrates an example of a PPDU used in the present specification.

FIG. 14 illustrates an example of a modified transmission device and/or receiving device of the present specification.

FIG. 15 shows an example of an aggregation of RU26 and RU52 in 20 MHz.

FIG. 16 shows an example of an aggregation of RU26 and RU52 in 40 MHz.

FIG. 17 shows an example of an aggregation of RU26 and RU52 in 80 MHz.

FIG. 18 shows an example of an EHT PPDU.

FIG. 19 shows an example of a U-SIG.

FIG. 20 shows an example of a PPDU including an EHT-SIG.

FIG. 21 shows an example of a PPDU including an EHT-SIG.

FIG. 22 shows an example of a PPDU including an EHT-SIG.

FIG. 23 shows an example of a PPDU including an EHT-SIG.

FIG. 24 shows an example of a PPDU including an EHT-SIG.

FIG. 25 shows an example of a PPDU including an EHT-SIG.

FIG. 26 shows an example of a PPDU including an EHT-SIG.

FIG. 27 shows an example of a PPDU including an EHT-SIG.

FIGS. 28 to 31 show examples of 3×996 RU aggregation.

FIG. 32 is a flowchart illustrating an operation of a receiving STA.

FIG. 33 is a flowchart illustrating an operation of a transmitting STA.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

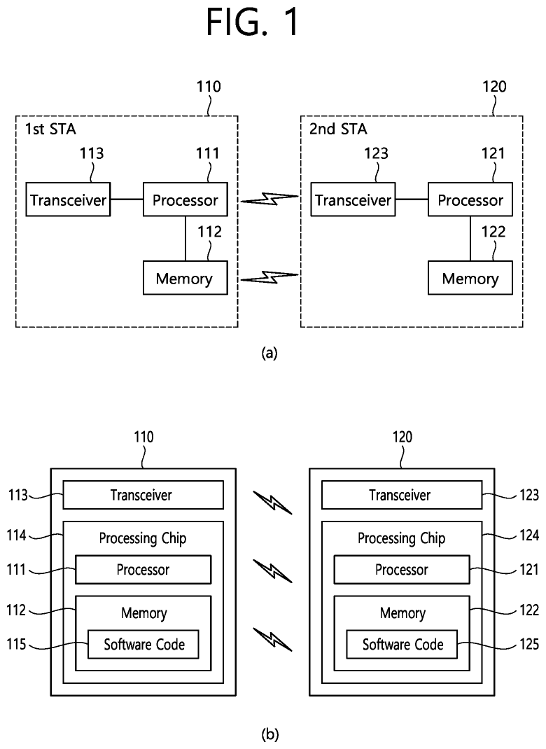

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

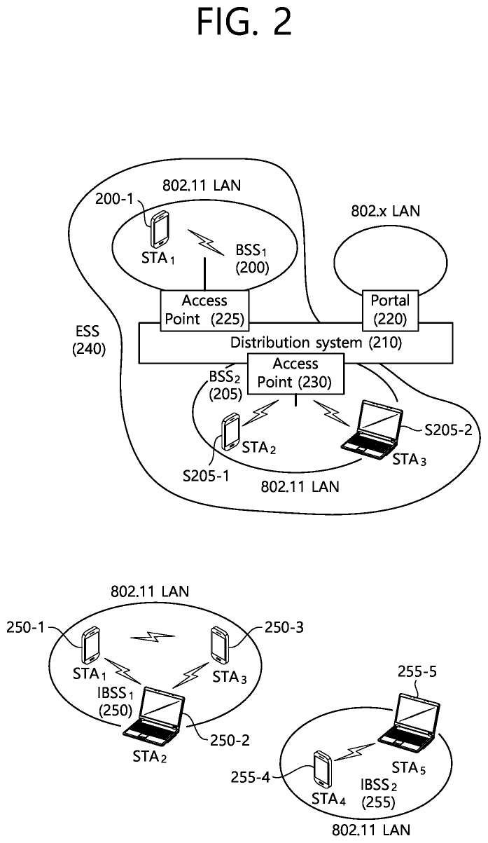

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

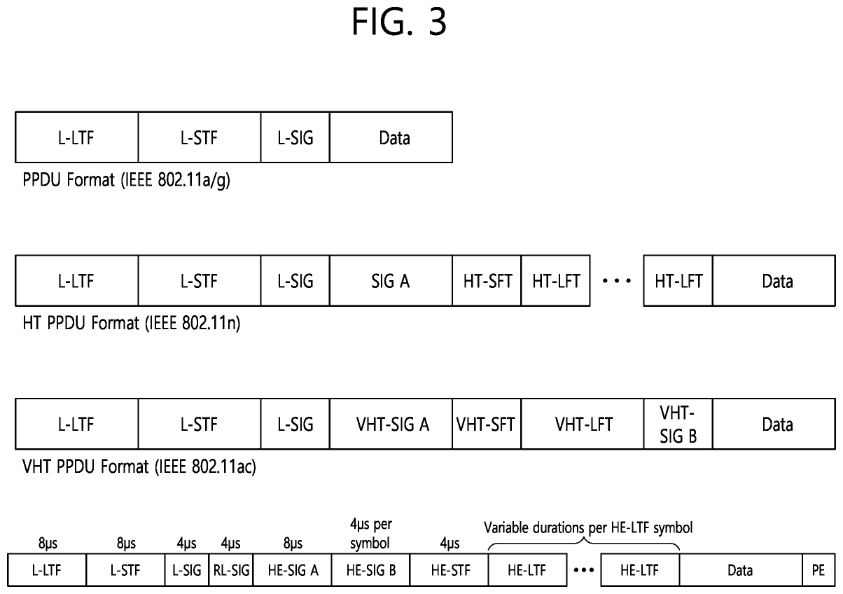

FIG. 3 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 3 also includes an example of an HE PPDU according to IEEE 802.11ax. The HE PPDU according to FIG. 3 is an illustrative PPDU for multiple users. An HE-SIG-B may be included only in a PPDU for multiple users, and an HE-SIG-B may be omitted in a PPDU for a single user.

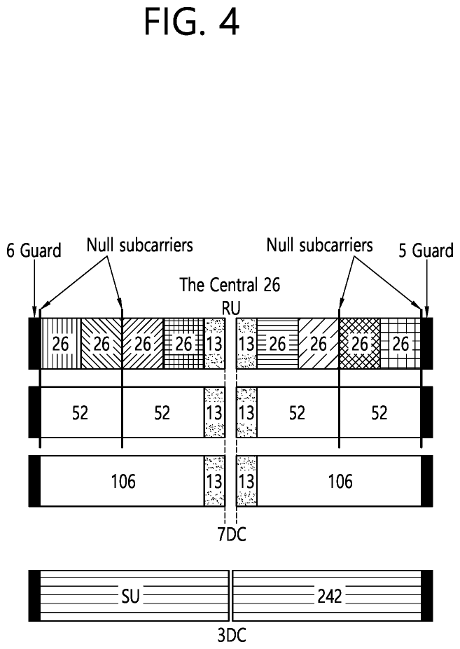

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

FIG. 4 illustrates a layout of resource units (RUs) used in a band of 20 MHz.

As illustrated in FIG. 4, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 4, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 4 may be used not only for a multiple users (MUs) but also for a single user (SU), in which case one 242-unit may be used and three DC tones may be inserted as illustrated in the lowermost part of FIG. 4.

Although FIG. 4 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

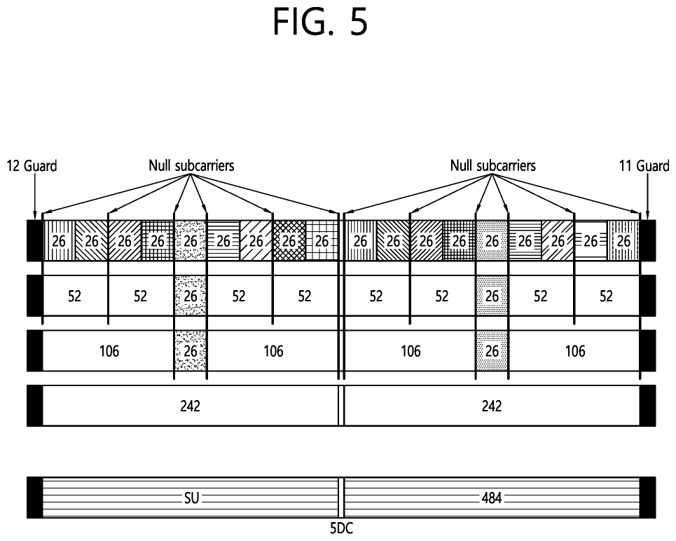

FIG. 5 illustrates a layout of RUs used in a band of 40 MHz.

Similarly to FIG. 4 in which RUs having various sizes are used, a 26-RU, a 52-RU, a 106-RU, a 242-RU, a 484-RU, and the like may be used in an example of FIG. 5. Further, five DC tones may be inserted in a center frequency, 12 tones may be used for a guard band in the leftmost band of the 40 MHz band, and 11 tones may be used for a guard band in the rightmost band of the 40 MHz band.

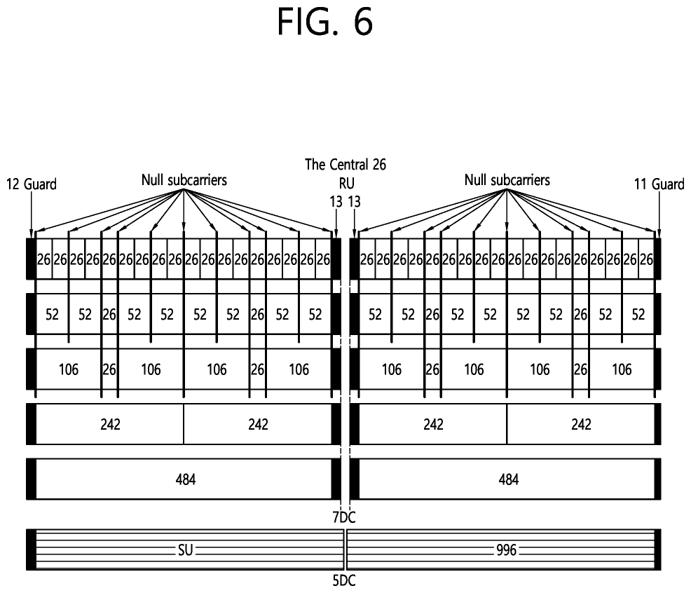

As illustrated in FIG. 6, when the layout of the RUs is used for a single user, a 484-RU may be used. The specific number of RUs may be changed similarly to FIG. 5.

FIG. 6 illustrates a layout of RUs used in a band of 80 MHz.

Similarly to FIG. 4 and FIG. 5 in which RUs having various sizes are used, a 26-RU, a 52-RU, a 106-RU, a 242-RU, a 484-RU, a 996-RU, and the like may be used in an example of FIG. 6. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

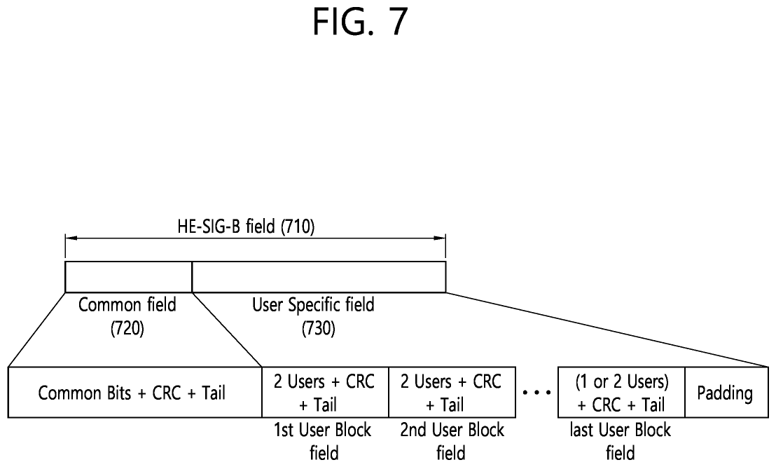

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

FIG. 7 illustrates a structure of an HE-SIG-B field.

As illustrated, an HE-SIG-B field 710 includes a common field 720 and a user-specific field 730. The common field 720 may include information commonly applied to all users (i.e., user STAs) which receive SIG-B. The user-specific field 730 may be called a user-specific control field. When the SIG-B is transferred to a plurality of users, the user-specific field 730 may be applied only any one of the plurality of users.

As illustrated in FIG. 7, the common field 720 and the user-specific field 730 may be separately encoded.

The common field 720 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

As shown the example of FIG. 4, up to nine 26-RUs may be allocated to the 20 MHz channel. When the RU allocation information of the common field 720 is set to “00000000” as shown in Table 1, the nine 26-RUs may be allocated to a corresponding channel (i.e., 20 MHz). In addition, when the RU allocation information of the common field 720 is set to “00000001” as shown in Table 1, seven 26-RUs and one 52-RU are arranged in a corresponding channel. That is, in the example of FIG. 4, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 7, the user-specific field 730 may include a plurality of user fields. As described above, the number of STAs (e.g., user STAs) allocated to a specific channel may be determined based on the RU allocation information of the common field 720. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

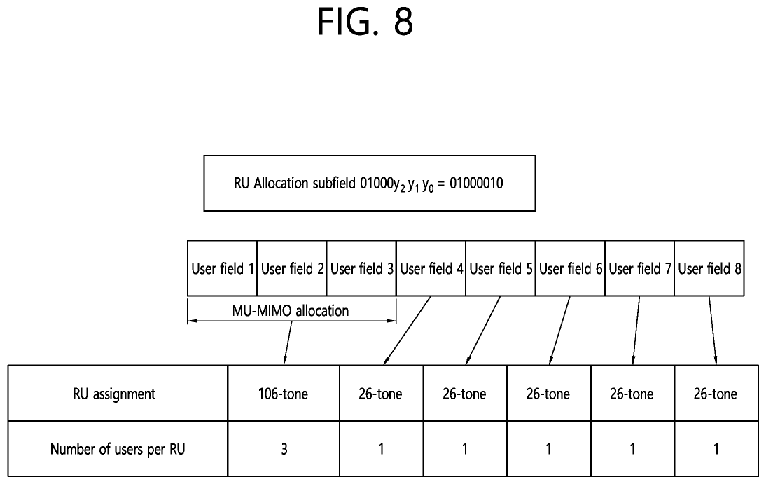

For example, when RU allocation is set to “O1000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 8.

FIG. 8 illustrates an example in which a plurality of user STAs are allocated to the same RU through a MU-MIMO scheme.

For example, when RU allocation is set to “01000010” as shown in FIG. 7, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 730 of HE-SIG-B may include eight user fields.

The eight user fields may be expressed in the order shown in FIG. 8. In addition, as shown in FIG. 7, two user fields may be implemented with one user block field.

The user fields shown in FIG. 7 and FIG. 8 may be configured based on two formats. That is, a user field related to a MU-MIMO scheme may be configured in a first format, and a user field related to a non-MIMO scheme may be configured in a second format. Referring to the example of FIG. 8, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration. Specifically, an example of the second bit (i.e., B11-B14) may be as shown in Table 3 and Table 4 below.

TABLE 3

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 2 | 0000-0011 | 1-4 | 1 | | | | | | | 2-5 | 10 |
| | 0100-0110 | 2-4 | 2 | | | | | | | 4-6 | |
| | 0111-1000 | 3-4 | 3 | | | | | | | 6-7 | |
| | 1001 | 4 | 4 | | | | | | | 8 | |
| 3 | 0000-0011 | 1-4 | 1 | 1 | | | | | | 3-6 | 13 |
| | 0100-0110 | 2-4 | 2 | 1 | | | | | | 5-7 | |
| | 0111-1000 | 3-4 | 3 | 1 | | | | | | 7-8 | |
| | 1001-1011 | 2-4 | 2 | 2 | | | | | | 6-8 | |
| | 1100 | 3 | 3 | 2 | | | | | | 8 | |
| 4 | 0000-0011 | 1-4 | 1 | 1 | 1 | | | | | 4-7 | 11 |
| | 0100-0110 | 2-4 | 2 | 1 | 1 | | | | | 6-8 | |
| | 0111 | 3 | 3 | 1 | 1 | | | | | 8 | |
| | 1000-1001 | 2-3 | 2 | 2 | 1 | | | | | 7-8 | |
| | 1010 | 2 | 2 | 2 | 2 | | | | | 8 | |

TABLE 4

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 5 | 0000-0011 | 1-4 | 1 | 1 | 1 | 1 | | | | 5-8 | 7 |
| | 0100-0101 | 2-3 | 2 | 1 | 1 | 1 | | | | 7-8 | |
| | 0110 | 2 | 2 | 2 | 1 | 1 | | | | 8 | |
| 6 | 0000-0010 | 1-3 | 1 | 1 | 1 | 1 | 1 | | | 6-8 | 4 |
| | 0011 | 2 | 2 | 1 | 1 | 1 | 1 | | | 8 | |
| 7 | 0000-0001 | 1-2 | 1 | 1 | 1 | 1 | 1 | 1 | | 7-8 | 2 |
| 8 | 0000 | 1 | 1 | 1 | 1 | 1 | 1 | 1 | 1 | 8 | 1 |

As shown in Table 3 and/or Table 4, the second bit (e.g., B11-B14) may include information related to the number of spatial streams allocated to the plurality of user STAs which are allocated based on the MU-MIMO scheme. For example, when three user STAs are allocated to the 106-RU based on the MU-MIMO scheme as shown in FIG. 8, N_user is set to “3”. Therefore, values of N_STS[1], N_STS[2], and N_STS[3] may be determined as shown in Table 3. For example, when a value of the second bit (B11-B14) is “0011”, it may be set to N_STS[1]=4, N_STS[2]=1, N_STS[3]=1. That is, in the example of FIG. 8, four spatial streams may be allocated to the user field 1, one spatial stream may be allocated to the user field 1, and one spatial stream may be allocated to the user field 3.

As shown in the example of Table 3 and/or Table 4, information (i.e., the second bit, B11-B14) related to the number of spatial streams for the user STA may consist of 4 bits. In addition, the information (i.e., the second bit, B11-B14) on the number of spatial streams for the user STA may support up to eight spatial streams. In addition, the information (i.e., the second bit, B11-B14) on the number of spatial streams for the user STA may support up to four spatial streams for one user STA.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

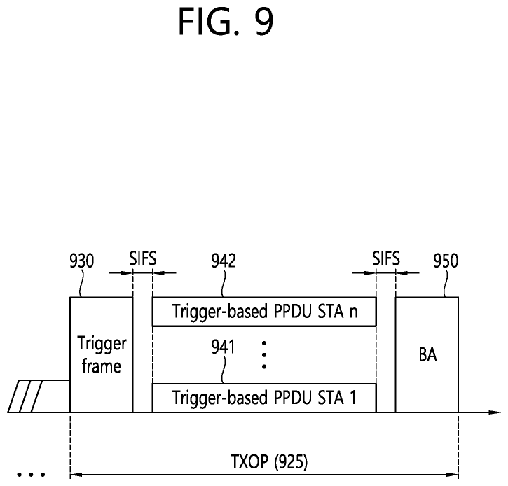

FIG. 9 illustrates an operation based on UL-MU. As illustrated, a transmitting STA (e.g., an AP) may perform channel access through contending (e.g., a backoff operation), and may transmit a trigger frame 930. That is, the transmitting STA may transmit a PPDU including the trigger frame 930. Upon receiving the PPDU including the trigger frame, a trigger-based (TB) PPDU is transmitted after a delay corresponding to SIFS.

TB PPDUs 941 and 942 may be transmitted at the same time period, and may be transmitted from a plurality of STAs (e.g., user STAs) having AIDs indicated in the trigger frame 930. An ACK frame 950 for the TB PPDU may be implemented in various forms.

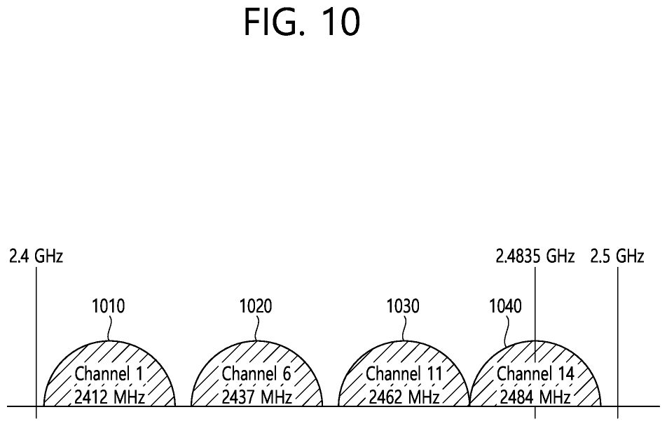

FIG. 10 illustrates an example of a channel used/supported/defined within a 2.4 GHz band.

The 2.4 GHz band may be called in other terms such as a first band. In addition, the 2.4 GHz band may imply a frequency domain in which channels of which a center frequency is close to 2.4 GHz (e.g., channels of which a center frequency is located within 2.4 to 2.5 GHz) are used/supported/defined.

A plurality of 20 MHz channels may be included in the 2.4 GHz band. 20 MHz within the 2.4 GHz may have a plurality of channel indices (e.g., an index 1 to an index 14). For example, a center frequency of a 20 MHz channel to which a channel index 1 is allocated may be 2.412 GHz, a center frequency of a 20 MHz channel to which a channel index 2 is allocated may be 2.417 GHz, and a center frequency of a 20 MHz channel to which a channel index N is allocated may be (2.407+0.005*N) GHz. The channel index may be called in various terms such as a channel number or the like. Specific numerical values of the channel index and center frequency may be changed.

FIG. 10 exemplifies 4 channels within a 2.4 GHz band. Each of 1st to 4th frequency domains 1010 to 1040 shown herein may include one channel. For example, the 1st frequency domain 1010 may include a channel 1 (a 20 MHz channel having an index 1). In this case, a center frequency of the channel 1 may be set to 2412 MHz. The 2nd frequency domain 1020 may include a channel 6. In this case, a center frequency of the channel 6 may be set to 2437 MHz. The 3rd frequency domain 1030 may include a channel 11. In this case, a center frequency of the channel 11 may be set to 2462 MHz. The 4th frequency domain 1040 may include a channel 14. In this case, a center frequency of the channel 14 may be set to 2484 MHz.

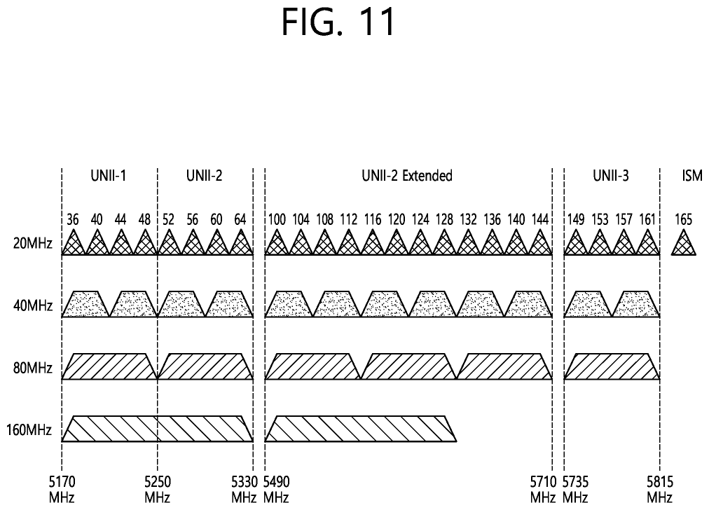

FIG. 11 illustrates an example of a channel used/supported/defined within a 5 GHz band.

The 5 GHz band may be called in other terms such as a second band or the like. The 5 GHz band may imply a frequency domain in which channels of which a center frequency is greater than or equal to 5 GHz and less than 6 GHz (or less than 5.9 GHz) are used/supported/defined. Alternatively, the 5 GHz band may include a plurality of channels between 4.5 GHz and 5.5 GHz. A specific numerical value shown in FIG. 11 may be changed.

A plurality of channels within the 5 GHz band include an unlicensed national information infrastructure (UNII)-1, a UNII-2, a UNII-3, and an ISM. The INII-1 may be called UNII Low. The UNII-2 may include a frequency domain called UNII Mid and UNII-2Extended. The UNII-3 may be called UNII-Upper.

A plurality of channels may be configured within the 5 GHz band, and a bandwidth of each channel may be variously set to, for example, 20 MHz, 40 MHz, 80 MHz, 160 MHz, or the like. For example, 5170 MHz to 5330 MHz frequency domains/ranges within the UNII-1 and UNII-2 may be divided into eight 20 MHz channels. The 5170 MHz to 5330 MHz frequency domains/ranges may be divided into four channels through a 40 MHz frequency domain. The 5170 MHz to 5330 MHz frequency domains/ranges may be divided into two channels through an 80 MHz frequency domain. Alternatively, the 5170 MHz to 5330 MHz frequency domains/ranges may be divided into one channel through a 160 MHz frequency domain.

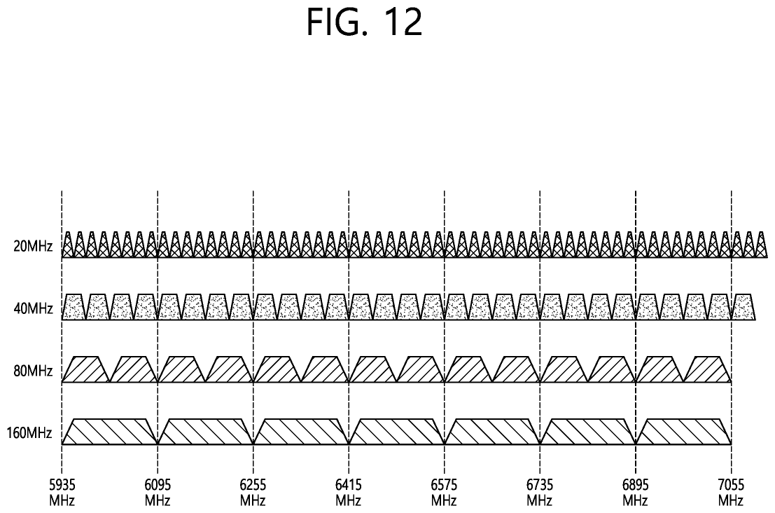

FIG. 12 illustrates an example of a channel used/supported/defined within a 6 GHz band.

The 6 GHz band may be called in other terms such as a third band or the like. The 6 GHz band may imply a frequency domain in which channels of which a center frequency is greater than or equal to 5.9 GHz are used/supported/defined. A specific numerical value shown in FIG. 12 may be changed.

For example, the 20 MHz channel of FIG. 12 may be defined starting from 5.940 GHz. Specifically, among 20 MHz channels of FIG. 12, the leftmost channel may have an index 1 (or a channel index, a channel number, etc.), and 5.945 GHz may be assigned as a center frequency. That is, a center frequency of a channel of an index N may be determined as (5.940+0.005*N) GHz.

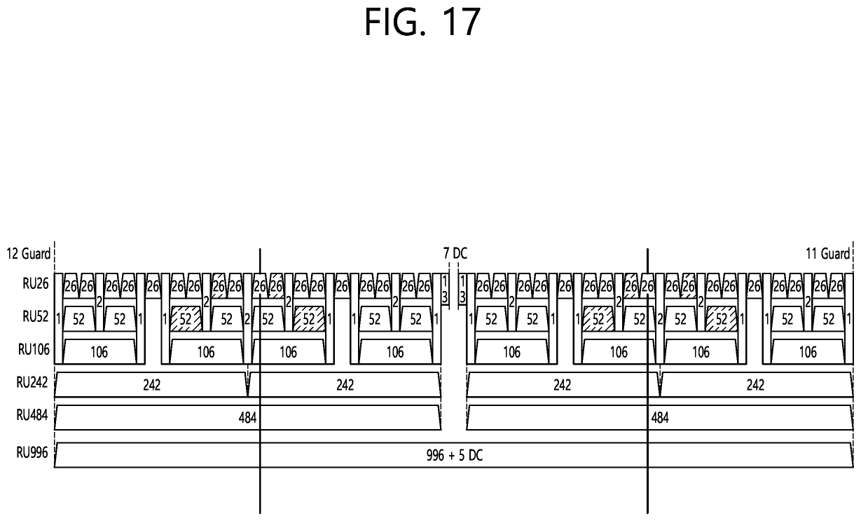

Accordingly, an index (or channel number) of the 2 MHz channel of FIG. 17 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. In addition, according to the aforementioned (5.940+0.005*N) GHz rule, an index of the 40 MHz channel of FIG. 17 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Although 20, 40, 80, and 160 MHz channels are illustrated in the example of FIG. 12, a 240 MHz channel or a 320 MHz channel may be additionally added.

Hereinafter, a PPDU transmitted/received in a STA of the present specification will be described.

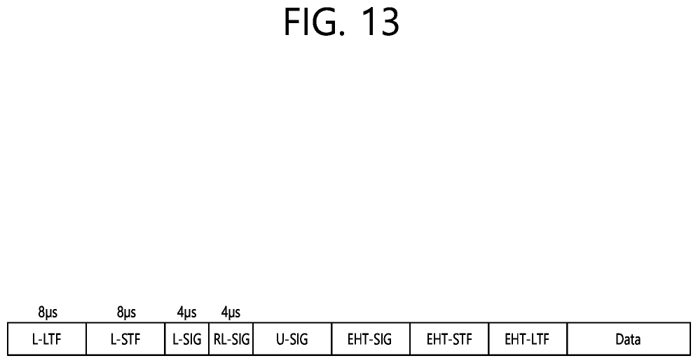

FIG. 13 illustrates an example of a PPDU used in the present specification.

The PPDU of FIG. 13 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 13 may indicate the entirety or part of a PPDU type used in the EHT system. For example, the example of FIG. 13 may be used for both of a single-user (SU) mode and a multi-user (MU) mode. In other words, the PPDU of FIG. 13 may be a PPDU for one receiving STA or a plurality of receiving STAs. When the PPDU of FIG. 13 is used for a trigger-based (TB) mode, the EHT-SIG of FIG. 13 may be omitted. In other words, a STA which has received a trigger frame for uplink-MU (UL-MU) may transmit the PPDU in which the EHT-SIG is omitted in the example of FIG. 13.

In FIG. 13, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 13 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 13, the L-LTE and the L-STF may be the same as those in the conventional fields.

The L-SIG field of FIG. 13 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier{subcarrier index −21, −7, +7, +21} and a DC subcarrier{subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index{−28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 13. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g., 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth; 2) a field including information related to an MCS scheme applied to EHT-SIG; 3) an indication field including information regarding whether a dual subcarrier modulation (DCM) scheme is applied to EHT-SIG; 4) a field including information related to the number of symbol used for EHT-SIG; 5) a field including information regarding whether the EHT-SIG is generated across a full band; 6) a field including information related to a type of EHT-LTF/STF; and 7) information related to a field indicating an EHT-LTF length and a CP length.

Preamble puncturing may be applied to the PPDU of FIG. 13. The preamble puncturing implies that puncturing is applied to part (e.g., a secondary 20 MHz band) of the full band. For example, when an 80 MHz PPDU is transmitted, a STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHz band within the 160 MHz band (or 80+80 MHz band).

Information related to the preamble puncturing applied to the PPDU may be included in U-SIG and/or EHT-SIG. For example, a first field of the U-SIG may include information related to a contiguous bandwidth, and second field of the U-SIG may include information related to the preamble puncturing applied to the PPDU.

For example, the U-SIG and the EHT-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an EHT-SIG contiguous to the first U-SIG may include information related to a preamble puncturing applied to the second 80 MHz band (i.e., information related to a preamble puncturing pattern), and an EHT-SIG contiguous to the second U-SIG may include information related to a preamble puncturing (i.e., information related to a preamble puncturing pattern) applied to the first 80 MHz band.

Additionally or alternatively, the U-SIG and the EHT-SIG may include the information related to the preamble puncturing, based on the following method. The U-SIG may include information related to a preamble puncturing (i.e., information related to a preamble puncturing pattern) for all bands. That is, the EHT-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The EHT-SIG of FIG. 13 may include control information for the receiving STA. The EHT-SIG may be transmitted through at least one symbol, and one symbol may have a length of 4 μs. Information related to the number of symbols used for the EHT-SIG may be included in the U-SIG.

The EHT-SIG may include a technical feature of the HE-SIG-B described with reference to FIG. 7 and FIG. 8. For example, the EHT-SIG may include a common field and a user-specific field as in the example of FIG. 7. The common field of the EHT-SIG may be omitted, and the number of user-specific fields may be determined based on the number of users.

As in the example of FIG. 7, the common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 8, each user field may be related to MU-MIMO allocation, or may be related to non-MU-MIMO allocation.

As in the example of FIG. 7, the common field of the EHT-SIG may include a CRC bit and a tail bit. A length of the CRC bit may be determined as 4 bits. A length of the tail bit may be determined as 6 bits, and may be set to ‘000000’.

As in the example of FIG. 7, the common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

The example of Table 5 to Table 7 is an example of 8-bit (or N-bit) information for various RU allocations. An index shown in each table may be modified, and some entries in Table 5 to Table 7 may be omitted, and entries (not shown) may be added.

The example of Table 5 to Table 7 relates to information related to a location of an RU allocated to a 20 MHz band. For example, ‘an index 0’ of Table 5 may be used in a situation where nine 26-RUs are individually allocated (e.g., in a situation where nine 26-RUs shown in FIG. 4 are individually allocated).

Meanwhile, a plurality or RUs may be allocated to one STA in the EHT system. For example, regarding ‘an index 60’ of Table 6, one 26-RU may be allocated for one user (i.e., receiving STA) to the leftmost side of the 20 MHz band, one 26-RU and one 52-RU may be allocated to the right side thereof, and five 26-RUs may be individually allocated to the right side thereof.

TABLE 5

| | | | | | | | | | | Number |
|---|---|---|---|---|---|---|---|---|---|---|
| Indices | #1 | #2 | #3 | #4 | #5 | #6 | #7 | #8 | #9 | of entries |
| 0 | 26 | 26 | 26 | 26 | 26 | 26 | 26 | 26 | 26 | 1 |

| | | | | | | | | | |
|---|---|---|---|---|---|---|---|---|---|
| 1 | 26 | 26 | 26 | 26 | 26 | 26 | 26 | 52 | 1 |

| | | | | | | | | | |
|---|---|---|---|---|---|---|---|---|---|
| 2 | 26 | 26 | 26 | 26 | 26 | 52 | 26 | 26 | 1 |

| | | | | | | | | |
|---|---|---|---|---|---|---|---|---|
| 3 | 26 | 26 | 26 | 26 | 26 | 52 | 52 | 1 |

| | | | | | | | | | |
|---|---|---|---|---|---|---|---|---|---|
| 4 | 26 | 26 | 52 | 26 | 26 | 26 | 26 | 26 | 1 |

| | | | | | | | | |
|---|---|---|---|---|---|---|---|---|
| 5 | 26 | 26 | 52 | 26 | 26 | 26 | 52 | 1 |

| | | | | | | | | |
|---|---|---|---|---|---|---|---|---|
| 6 | 26 | 26 | 52 | 26 | 52 | 26 | 26 | 1 |

| | | | | | | | |
|---|---|---|---|---|---|---|---|
| 7 | 26 | 26 | 52 | 26 | 52 | 52 | 1 |

| | | | | | | | | | |
|---|---|---|---|---|---|---|---|---|---|
| 8 | 52 | 26 | 26 | 26 | 26 | 26 | 26 | 26 | 1 |

| | | | | | | | | |
|---|---|---|---|---|---|---|---|---|
| 9 | 52 | 26 | 26 | 26 | 26 | 26 | 52 | 1 |

| | | | | | | | | |
|---|---|---|---|---|---|---|---|---|
| 10 | 52 | 26 | 26 | 26 | 52 | 26 | 26 | 1 |

| | | | | | | | |
|---|---|---|---|---|---|---|---|
| 11 | 52 | 26 | 26 | 26 | 52 | 52 | 1 |

| | | | | | | | | |
|---|---|---|---|---|---|---|---|---|
| 12 | 52 | 52 | 26 | 26 | 26 | 26 | 26 | 1 |

| | | | | | | | |
|---|---|---|---|---|---|---|---|
| 13 | 52 | 52 | 26 | 26 | 26 | 52 | 1 |

| | | | | | | | |
|---|---|---|---|---|---|---|---|
| 14 | 52 | 52 | 26 | 52 | 26 | 26 | 1 |

| | | | | | | |
|---|---|---|---|---|---|---|
| 15 | 52 | 52 | 26 | 52 | 52 | 1 |

| | | | | | | | |
|---|---|---|---|---|---|---|---|
| 16 | 26 | 26 | 26 | 26 | 26 | 106 | 1 |

| | | | | | | |
|---|---|---|---|---|---|---|
| 17 | 26 | 26 | 52 | 26 | 106 | 1 |

| | | | | | | |
|---|---|---|---|---|---|---|
| 18 | 52 | 26 | 26 | 26 | 106 | 1 |

| | | | | | |
|---|---|---|---|---|---|
| 19 | 52 | 52 | 26 | 106 | 1 |

TABLE 6

| | | | | | | | | | | Number |
|---|---|---|---|---|---|---|---|---|---|---|
| Indices | #1 | #2 | #3 | #4 | #5 | #6 | #7 | #8 | #9 | of entries |

| | | | | | | | |
|---|---|---|---|---|---|---|---|
| 20 | 106 | 26 | 26 | 26 | 26 | 26 | 1 |

| | | | | | | |
|---|---|---|---|---|---|---|
| 21 | 106 | 26 | 26 | 26 | 52 | 1 |

| | | | | | | |
|---|---|---|---|---|---|---|
| 22 | 106 | 26 | 52 | 26 | 26 | 1 |

| 23 | 106 | | 26 | 52 | 52 | 1 |
|---|---|---|---|---|---|---|
| 24 | 52 | 52 | — | 52 | 52 | 1 |

| 25 | 242-tone RU empty (with zero users) | | | | | | | 1 |
|---|---|---|---|---|---|---|---|---|
| 26 | 106 | | | | 26 | 106 | | 1 |
| 27-34 | 242 | | | | | | | 8 |
| 35-42 | 484 | | | | | | | 8 |
| 43-50 | 996 | | | | | | | 8 |
| 51-58 | 2*996 | | | | | | | 8 |
| 59 | 26 | 26 | 26 | 26 | 26 | 52 + 26 | 26 | 1 |

| | | | | | | | | |
|---|---|---|---|---|---|---|---|---|
| 60 | 26 | 26 + 52 | 26 | 26 | 26 | 26 | 26 | 1 |

| | | | | | | | |
|---|---|---|---|---|---|---|---|
| 61 | 26 | 26 + 52 | 26 | 26 | 26 | 52 | 1 |

| | | | | | | | |
|---|---|---|---|---|---|---|---|
| 62 | 26 | 26 + 52 | 26 | 52 | 26 | 26 | 1 |

| | | | | | | | |
|---|---|---|---|---|---|---|---|
| 63 | 26 | 26 | 52 | 26 | 52 + 26 | 26 | 1 |

| | | | | | | |
|---|---|---|---|---|---|---|
| 64 | 26 | 26 + 52 | 26 | 52 + 26 | 26 | 1 |

| | | | | | | |
|---|---|---|---|---|---|---|
| 65 | 26 | 26 + 52 | 26 | 52 | 52 | 1 |

TABLE 7

| | | | | | | | |
|---|---|---|---|---|---|---|---|
| 66 | 52 | 26 | 26 | 26 | 52 + 26 | 26 | 1 |

| | | | | | | |
|---|---|---|---|---|---|---|
| 67 | 52 | 52 | 26 | 52 + 26 | 26 | 1 |

| | | | | | |
|---|---|---|---|---|---|
| 68 | 52 | 52 + 26 | 52 | 52 | 1 |

| | | | | | | |
|---|---|---|---|---|---|---|
| 69 | 26 | 26 | 26 | 26 | 26 + 106 | 1 |

| | | | | | |
|---|---|---|---|---|---|
| 70 | 26 | 26 + 52 | 26 | 106 | 1 |

| | | | | | |
|---|---|---|---|---|---|
| 71 | 26 | 26 | 52 | 26 + 106 | 1 |

| | | | | |
|---|---|---|---|---|
| 72 | 26 | 26 + 52 | 26 + 106 | 1 |

| | | | | | |
|---|---|---|---|---|---|
| 73 | 52 | 26 | 26 | 26 + 106 | 1 |

| | | | | |
|---|---|---|---|---|
| 74 | 52 | 52 | 26 + 106 | 1 |

| | | | | | | |
|---|---|---|---|---|---|---|
| 75 | 106 + 26 | 26 | 26 | 26 | 26 | 1 |

| | | | | | |
|---|---|---|---|---|---|
| 76 | 106 + 26 | 26 | 26 | 52 | 1 |

| | | | | | |
|---|---|---|---|---|---|
| 77 | 106 + 26 | 52 | 26 | 26 | 1 |

| | | | | | |
|---|---|---|---|---|---|
| 78 | 106 | 26 | 52 + 26 | 26 | 1 |

| | | | | |
|---|---|---|---|---|
| 79 | 106 + 26 | 52 + 26 | 26 | 1 |

| | | | | |
|---|---|---|---|---|
| 80 | 106 + 26 | 52 | 52 | 1 |

| | | | |
|---|---|---|---|
| 81 | 106 + 26 | 106 | 1 |

| | | | |
|---|---|---|---|
| 82 | 106 | 26 + 106 | 1 |

A mode in which the common field of the EHT-SIG is omitted may be supported. The mode in which the common field of the EHT-SIG is omitted may be called a compressed mode. When the compressed mode is used, a plurality of users (i.e., a plurality of receiving STAs) may decode the PPDU (e.g., the data field of the PPDU), based on non-OFDMA. That is, the plurality of users of the EHT PPDU may decode the PPDU (e.g., the data field of the PPDU) received through the same frequency band. Meanwhile, when a non-compressed mode is used, the plurality of users of the EHT PPDU may decode the PPDU (e.g., the data field of the PPDU), based on OFDMA. That is, the plurality of users of the EHT PPDU may receive the PPDU (e.g., the data field of the PPDU) through different frequency bands.

The EHT-SIG may be configured based on various MCS schemes. As described above, information related to an MCS scheme applied to the EHT-SIG may be included in U-SIG. The EHT-SIG may be configured based on a DCM scheme. For example, among N data tones (e.g., 52 data tones) allocated for the EHT-SIG, a first modulation scheme may be applied to half of contiguous tones, and a second modulation scheme may be applied to the remaining half of the contiguous tones. That is, a transmitting STA may use the first modulation scheme to modulate specific control information through a first symbol and allocate it to half of the contiguous tones, and may use the second modulation scheme to modulate the same control information by using a second symbol and allocate it to the remaining half of the contiguous tones. As described above, information (e.g., a 1-bit field) regarding whether the DCM scheme is applied to the EHT-SIG may be included in the U-SIG.

An HE-STF of FIG. 13 may be used for improving automatic gain control estimation in a multiple input multiple output (MIMO) environment or an OFDMA environment. An HE-LTF of FIG. 13 may be used for estimating a channel in the MIMO environment or the OFDMA environment.

A PPDU (e.g., EHT-PPDU) of FIG. 13 may be configured based on the example of FIG. 4 and FIG. 5.

For example, an EHT PPDU transmitted on a 20 MHz band, i.e., a 20 MHz EHT PPDU, may be configured based on the RU of FIG. 4. That is, a location of an RU of EHT-STF, EHT-LTF, and data fields included in the EHT PPDU may be determined as shown in FIG. 4.

An EHT PPDU transmitted on a 40 MHz band, i.e., a 40 MHz EHT PPDU, may be configured based on the RU of FIG. 5. That is, a location of an RU of EHT-STF, EHT-LTF, and data fields included in the EHT PPDU may be determined as shown in FIG. 5.

Since the RU location of FIG. 5 corresponds to 40 MHz, a tone-plan for 80 MHz may be determined when the pattern of FIG. 5 is repeated twice. That is, an 80 MHz EHT PPDU may be transmitted based on a new tone-plan in which not the RU of FIG. 6 but the RU of FIG. 5 is repeated twice.

When the pattern of FIG. 5 is repeated twice, 23 tones (i.e., 11 guard tones+12 guard tones) may be configured in a DC region. That is, a tone-plan for an 80 MHz EHT PPDU allocated based on OFDMA may have 23 DC tones. Unlike this, an 80 MHz EHT PPDU allocated based on non-OFDMA (i.e., a non-OFDMA full bandwidth 80 MHz PPDU) may be configured based on a 996-RU, and may include 5 DC tones, 12 left guard tones, and 11 right guard tones.

A tone-plan for 160/240/320 MHz may be configured in such a manner that the pattern of FIG. 5 is repeated several times.

The PPDU of FIG. 13 may be determined (or identified) as an EHT PPDU based on the following method.

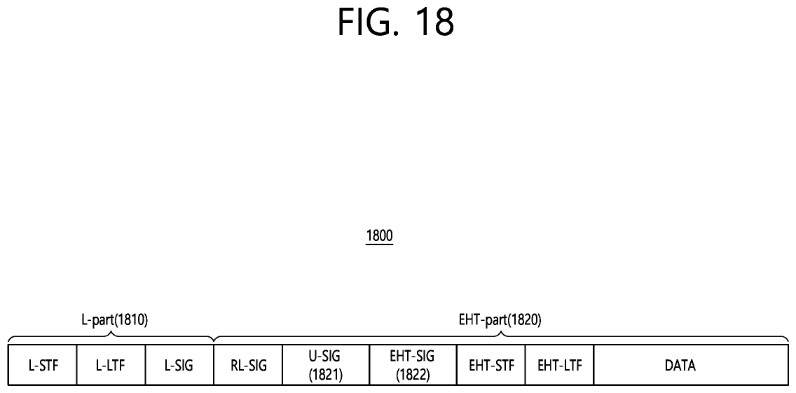

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “modulo 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 18. In other words, the receiving STA may determine the RX PPDU as the EHT PPDU, based on: 1) a first symbol after an L-LTF signal, which is a BPSK symbol; 2) RL-SIG contiguous to the L-SIG field and identical to L-SIG; 3) L-SIG including a length field in which a result of applying “modulo 3” is set to “0”; and 4) a 3-bit PHY version identifier of the aforementioned U-SIG (e.g., a PHY version identifier having a first value).

For example, the receiving STA may determine the type of the RX PPDU as the EHT PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “modulo 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 13. The PPDU of FIG. 13 may be used to transmit/receive frames of various types. For example, the PPDU of FIG. 13 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 13 may be used for a management frame. An example of the management frame may include a beacon frame, a (re-)association request frame, a (re-)association response frame, a probe request frame, and a probe response frame. For example, the PPDU of FIG. 13 may be used for a data frame. For example, the PPDU of FIG. 18 may be used to simultaneously transmit at least two or more of the control frame, the management frame, and the data frame.

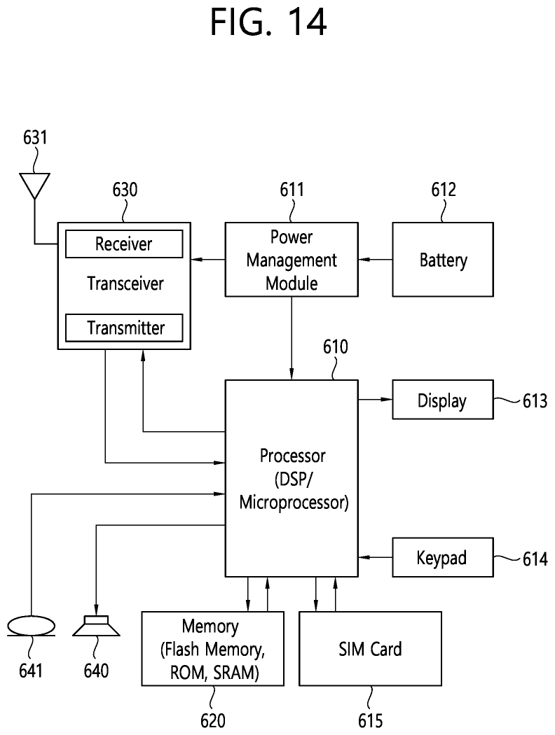

FIG. 14 illustrates an example of a modified transmission device and/or receiving device of the present specification.

Each device/STA of the sub-figure (a)/(b) of FIG. 1 may be modified as shown in FIG. 14. A transceiver 630 of FIG. 14 may be identical to the transceivers 113 and 123 of FIG. 1. The transceiver 630 of FIG. 14 may include a receiver and a transmitter.

A processor 610 of FIG. 14 may be identical to the processors 111 and 121 of FIG. 1. Alternatively, the processor 610 of FIG. 14 may be identical to the processing chips 114 and 124 of FIG. 1.

A memory 620 of FIG. 14 may be identical to the memories 112 and 122 of FIG. 1. Alternatively, the memory 620 of FIG. 14 may be a separate external memory different from the memories 112 and 122 of FIG. 1.

Referring to FIG. 14, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 14, a speaker 640 may output a result related to a sound processed by the processor 610. A microphone 641 may receive an input related to a sound to be used by the processor 610.

Hereinafter, technical features applicable to the EHT standard will be described.

According to an embodiment of the present specification, the EHT standard may support PPDUs of 320 MHz bandwidth and 160+160 MHz. In addition, 240 MHz transmission and 160+80 MHz transmission may be supported. The 240 MHz transmission and 160+80 MHz transmission may be configured by applying 80 MHz preamble puncturing in 320 MHz bandwidth and 160+160 MHz bandwidth, respectively. For example, the 240 MHz bandwidth and 160+80 MHz bandwidth may be configured based on three 80 MHz channels including a primary 80 MHz (channel).

According to an embodiment of the present specification, the EHT standard may re-use a tone plan of the IEEE 802.11ax standard a 20/40/80/160/80+80 MHz PPDU. According to an embodiment, a 160 MHz OFDMA tone plan of the IEEE 802.11ax standard may be duplicated and used for 320 MHz and 160+160 MHz PPDUs.

According to an embodiment of the present specification, the transmission in 240 MHz and 160+80 MHz may consist of three 80 MHz segments. For example, the tone plan of each 80 MHz segment may be configured in the same manner as the 80 MHz tone plan of the IEEE 802.11ax standard.

According to an embodiment of the present specification, a 160 MHz tone plan may be duplicated and used for a non-OFDMA tone plan of a 320/160+160 MHz PPDU.

According to an embodiment of the present specification, a duplicated HE160 tone plan may be used for a 320/160+160 MHz PPDU non-OFDMA tone plan.

According to an embodiment of the present specification, in each 160 MHz segment for a non-OFDMA tone plan of a 320/160+160 MHz PPDU, 12 and 11 null tones may be configured on the leftmost side and the rightmost side, respectively.

According to an embodiment of the present specification, the data part of the EHT PPDU may use the same subcarrier spacing as the data part of the IEEE 802.11ax standard.

Hereinafter, technical features of a resource unit (RU) applicable to the EHT standard will be described.

According to an embodiment of the present specification, in the EHT standard, one or more RUs may be allocated to a single STA. For example, coding and interleaving schemes for multiple RUs allocated to a single STA may be variously set.

According to an embodiment of the present specification, small-size RUs may be aggregated with other small-size RUs. According to an embodiment of the present specification, large-size RUs may be aggregated with other large-size RUs.

For example, RUs of 242 tones or more may be defined/set as ‘large-size RUs’. For another example, RUs of less than 242 tones may be defined/configured as ‘small size RUs’.

According to an embodiment of the present specification, there may be one PSDU per STA for each link. According to an embodiment of the present specification, for LDPC encoding, one encoder may be used for each PSDU.

Small-Size RUs

According to an embodiment of the present specification, an aggregation of small-size RUs may be set so as not to cross a 20 MHz channel boundary. For example, RU106+RU26 and RU52+RU26 may be configured as an aggregation of small-size RUs.

According to an embodiment of the present specification, in PPDUs of 20 MHz and 40 MHz, contiguous RU26 and RU106 may be aggregated/combined within a 20 MHz boundary.

According to an embodiment of the present specification, in PPDUs of 20 MHz and 40 MHz, RU26 and RU52 may be aggregated/combined.

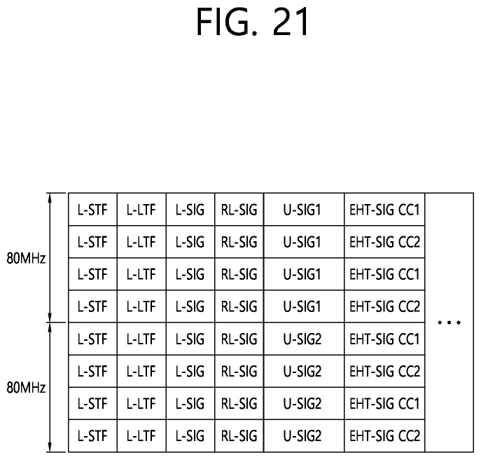

For example, in 20 MHz (or 20 MHz PPDU), an example of contiguous RU26 and RU52 may be shown through FIG. 21.

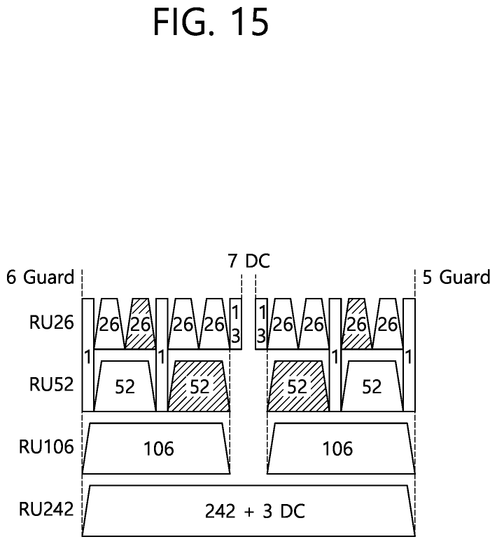

FIG. 15 shows an example of an aggregation of RU26 and RU52 in 20 MHz.

Referring to FIG. 15, shaded RU26 and RU52 may be aggregated. For example, the second RU26 and the second RU52 may be aggregated. For another example, the seventh RU and the third RU52 may be aggregated.

For example, in 40 MHz, an example of contiguous RU26 and RU52 is described in FIG. 15.

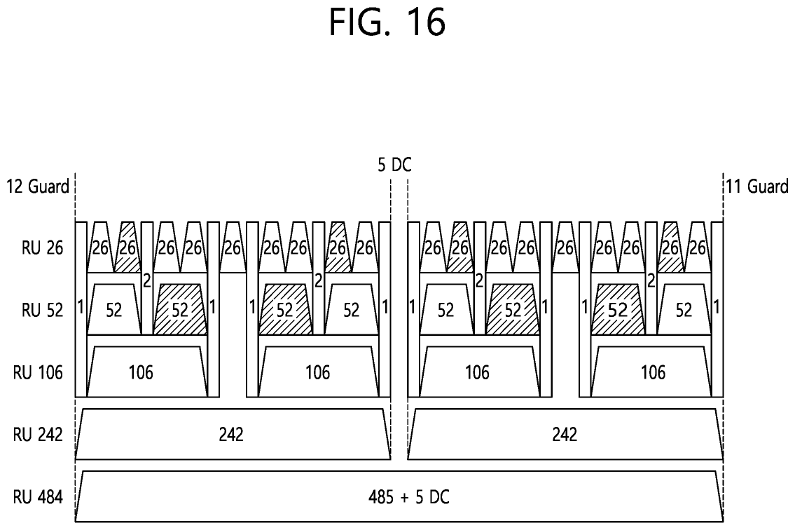

FIG. 16 shows an example of an aggregation of RU26 and RU52 in 40 MHz.

Referring to FIG. 16, shaded RU26 and RU52 may be aggregated. For example, the second RU26 and the second RU52 may be aggregated. For another example, the eighth RU26 and the third RU52 may be aggregated. For another example, the eleventh RU26 and the sixth RU52 may be aggregated. For another example, the seventeenth RU26 and the seventh RU52 may be aggregated.

According to an embodiment of the present specification, RU26 and RU52 may be aggregated/combined in a PPDU of 80 MHz.

For example, an example of contiguous RU26 and RU52 in 80 MHz may be shown by FIG. 17.

FIG. 17 shows an example of an aggregation of RU26 and RU52 in 80 MHz.

Referring to FIG. 17, 80 MHz may be divided into the first 40 MHz and the second 40 MHz. For example, within the first 40 MHz, the 8th RU26 and the 3rd RU52 may be aggregated. For another example, within the first 40 MHz, the 11th RU26 and the 6th RU52 may be aggregated. For another example, within the second 40 MHz, the 8th RU26 and the 3rd RU52 may be aggregated. For another example, within the second 40 MHz, the 11th RU26 and the 6th RU52 may be aggregated.

According to an embodiment, when LDPC coding is applied, a single tone mapper may be used for RUs having less than 242 tones.

Large-Size RUs

According to an embodiment, in OFDMA transmission of 320/160+160 MHz for a single STA, an aggregation of a large-size RUs may be allowed only within a primary 160 MHz or a secondary 160 MHz. For example, the primary 160 MHz (channel) may consist of a primary 80 MHz (channel) and a secondary 80 MHz (channel). The secondary 160 MHz (channel) can be configured with channels other than the primary 160 MHz.

According to an embodiment, in OFDMA transmission of 240 MHz for a single STA, an aggregated of large-size RUs may be allowed only within 160 MHz (band/channel), and the 160 MHz may consist of two adjacent 80 MHz channels.

According to an embodiment, in OFDMA transmission of 160+80 MHz for a single STA, an aggregation of large-size RUs may be allowed only within a continuous 160 MHz (band/channel) or within the remaining 80 MHz (band/channel).

In 160 MHz OFDMA, an aggregation of large-size RUs configured as shown in Table 8 may be supported.

TABLE 8

| RU size | Aggregate BW | Notes |
|---|---|---|
| 484 + 996 | 120 MHz | 4 options |

In 80 MHz OFDMA, an aggregation of large-size RUs configured as shown in Table 9 may be supported.

TABLE 9

| RU size | Aggregate BW | Notes |
|---|---|---|
| 484 + 242 | 60 MHz | 4 options |

In 80 MHz non-OFDMA, an aggregation of large-size RUs configured as shown in Table 10 may be supported. In 80 MHz non-OFDMA, puncturing can be applied. For example, one of four 242 RUs may be punctured.

TABLE 10

| RU size | Aggregate BW | Notes |
|---|---|---|
| 484 + 242 | 60 MHz | 4 options |

In 160 MHz non-OFDMA, an aggregation of large-size RUs configured as shown in Table 11 may be supported. In 160 MHz non-OFDMA, puncturing can be applied. For example, one of eight 242 RUs may be punctured. For another example, one of four 484 RUs may be punctured.

TABLE 11

| 80 MHz | 80 MHz | | |
|---|---|---|---|
| RU Size | RU size | Aggregate BW | Notes |
| 484 | 996 | 120 MHz | 4 options |
| 484 + 242 | 996 | 140 MHz | 8 options |

In 240 MHz non-OFDMA, an aggregation of large-size RUs configured as shown in Table 12 may be supported. In 240 MHz non-OFDMA, puncturing can be applied. For example, one of six 484 RUs may be punctured. For another example, one of three 996 RUs may be punctured.

TABLE 12

| 80 MHz | 80 MHz | 80 MHz | | |
|---|---|---|---|---|
| RU size | RU size | RU size | Aggregate BW | Notes |
| 484 | 996 | 996 | 200 MHz | 6 options |
| — | 996 | 996 | 160 MHz | 3 options |

In 320 MHz non-OFDMA, an aggregation of large-size RUs configured as shown in Table 13 may be supported. In 320 MHz non-OFDMA, puncturing can be applied. For example, one of eight 484 RUs may be punctured. For another example, one of four 996 RUs may be punctured.

TABLE 13

| 80 MHz | 80 MHz | 80 MHz | 80 MHz | | |
|---|---|---|---|---|---|
| RU size | RU size | RU size | RU size | Aggregate BW | Notes |
| 484 | 996 | 996 | 996 | 280 MHz | 8 options |
| — | 996 | 996 | 996 | 240 MHz | 4 options |

Hereinafter, technical features related to the operating mode will be described.

According to an embodiment, a station (STA) supporting the EHT standard STA (hereinafter, “EHT STA”) or a station (STA) supporting the EHT standard STA (hereinafter, “HE STA”) may operate in a 20 MHz channel width mode. In the 20 MHz channel width mode, the EHT STA may operate by reducing the operating channel width to 20 MHz using an operating mode indication (OMI).

According to an embodiment, the EHT STA (or HE STA) may operate in an 80 MHz channel width mode. For example, in the 80 MHz channel width mode, the EHT STA may operate by reducing the operating channel width to 80 MHz using an operating mode indication (OMI).

According to an embodiment, the EHT STA may support sub-channel selective transmission (SST). An STA supporting the SST can quickly select (and switch to) another channel between transmissions to cope with fading in a narrow sub-channel.

The 802.11be standard (i.e., the EHT standard) can provide a higher data rate than the 802.11ax standard. The EHT (i.e., extreme high throughput) standard can support wide bandwidth (up to 320 MHz), 16 streams, and multi-band operation.

In the EHT standard, various preamble puncturing or multiple RU allocation may be supported in wide bandwidth (up to 320 MHz) and SU/MU transmission. In addition, in the EHT standard, a signal transmission/reception method through 80 MHz segment allocation is considered in order to support an STA with low end capability (e.g., 80 MHz only operating STA). Accordingly, in the following specification, a method of configuring/transmitting an EHT-SIG for the MU transmission in consideration of sub-channel selective transmission (SST) defined in the 11ax standard and Multi-RU aggregation may be proposed. For example, the EHT-SIG may be configured as a self-contained EHT-SIG. When the self-contained EHT-SIG is used, a technical feature for signaling RU allocation may be proposed in the present specification.

EHT PPDU Configuration

In order to support a transmission method based on the EHT standard, a new frame format may be used. When transmitting a signal through the 2.4/5/6 GHz band based on the new frame format, conventional Wi-Fi receivers (or STAs) (e.g., 802.11n) as well as receivers supporting the EHT standard receivers in compliance with the 802.11n/ac/ax standard) can also receive EHT signals transmitted through the 2.4/5/6 GHz band.

The preamble of the PPDU based on the EHT standard can be set in various ways. Hereinafter, an embodiment of configuring the preamble of the PPDU based on the EHT standard will be described. Hereinafter, a PPDU based on the EHT standard may be described as an EHT PPDU. However, the EHT PPDU is not limited to the EHT standard. The EHT PPDU may include not only the 802.11be standard (i.e., the EHT standard), but also a PPDU based on a new standard that is improved/evolved/extended with the 802.11be standard.

FIG. 18 shows an example of an EHT PPDU.

Referring to FIG. 18, an EHT PPDU 1800 may include an L-part 1810 and an EHT-part 1820. The EHT PPDU 1800 may be configured in a format to support backward compatibility. In addition, the EHT PPDU 1800 may be transmitted to a single STA and/or multiple STAs. The EHT PPDU 1800 may be an example of an MU-PPDU of the EHT standard.

The EHT PPDU 1800 may include the L-part 1810 preceding the EHT-part 1820 for coexistence or backward compatibility with a legacy STA (e.g., STA in compliance with the 802.11n/ac/ax standard). For example, the L-part 1810 may include L-STF, L-LTF, and L-SIG. For example, phase rotation may be applied to the L-part 1810.

According to an embodiment, the EHT part 1820 may include RL-SIG, U-SIG 1821, EHT-SIG 1822, EHT-STF, EHT-LTF, and data fields. Similar to the 11ax standard, RL-SIG may be included in the EHT part 1820 for L-SIG reliability and range extension. The RL-SIG may be transmitted immediately after the L-SIG, and may be configured to repeat the L-SIG.

For example, four additional subcarriers may be applied to L-SIG and RL-SIG. The extra subcarriers may be configured at subcarrier indices [−28, −27, 27, 28]. The extra subcarriers may be modulated in a BPSK scheme. In addition, coefficients of [−1 −1 −1 1] may be mapped to the extra subcarriers.

For example, the EHT-LTF may be one of 1× EHT-LTF, 2× EHT-LTF, or 4× EHT-LTF. The EHT standard may support EHT-LTF for 16 spatial streams.

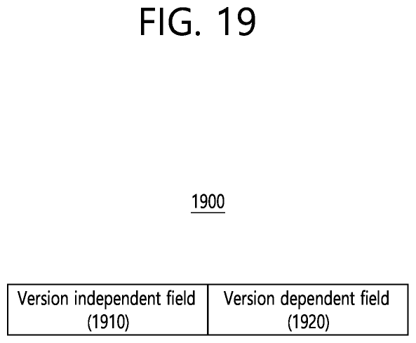

According to an embodiment, the U-SIG 1821 may include a version-independent field and a version-dependent field. An example of a U-SIG 1821 may be described with reference to FIG. 19.

FIG. 19 shows an example of a U-SIG.

Referring to FIG. 19, the U-SIG 1900 may correspond to the U-SIG 1821 of FIG. 18. The U-SIG 1900 may include a Version-independent field 1910 and a Version-dependent field 1920.

According to an embodiment, the version-independent field 1910 may include a version identifier of 3 bits indicating the EHT standard and the Wi-Fi version after the EHT standard. In other words, the version-independent field 1910 may include 3 bits of information about the EHT standard and the Wi-Fi version after the EHT standard.

According to an embodiment, the version-independent field 1910 may further include a 1-bit DL/UL field, a BSS color field, and/or a TXOP duration field. In other words, the version-independent field 1910 may further include 1-bit information related to DL/UL, information related to BSS color, and/or information related to TXOP duration.

According to an embodiment, the version-dependent field 1920 may include a field/information about a PPDU format type, a field/information about bandwidth, and/or a field/information about an MCS. For example, the field/information about the bandwidth may include puncturing information.

According to an embodiment, the U-SIG 1900 may be composed of two symbols. The two symbols may be jointly encoded. According to an embodiment, the U-SIG 1900 may be configured with 52 data tones and 4 pilot tones for each 20 MHz. In addition, it may be modulated in the same manner as HE-SIG-A of the HE standard. For example, the U-SIG 1900 may be modulated with BPSK and a code rate of 1/2.

According to an embodiment, the U-SIG 1900 may be transmitted by duplication in units of 20 MHz during wide bandwidth transmission.

According to an embodiment, when the U-SIG 1900 is transmitted to multiple users, it may further include information about the number of symbols of the EHT-SIG or MCS information of the EHT-SIG.

Referring back to FIG. 18, the EHT-SIG 1822 may include a version-dependent field that is not included in the U-SIG 1821. In other words, the EHT-SIG 1822 may include information overflowed from the U-SIG 1821. For example, the EHT-SIG 1822 may include information dependent on the version of the PPDU. As another example, the EHT-SIG 1822 may include at least some of the fields included in HE-SIG-A of the HE specification.

According to an embodiment, the EHT-SIG 1822 may be composed of a plurality of OFDM symbols. According to an embodiment, the EHT-SIG 1822 may be modulated with various MCSs. For example, EHT-SIG 1822 may be modulated based on MCSO through MCS5.

According to an embodiment, the EHT-SIG 1822 may include a common field and a user-specific field. For example, the common field may include information related to spatial stream and/or information related to RU allocation. For example, the user-specific field may include at least one user block field including information about the user. The user-specific field may include/indicate information used for a specific user or STA, information related to ID, MCS, and coding. As an example, the user-specific field may include at least one user block field.

In the following specification, RU aggregation (or preamble puncturing pattern) that can be used in the EHT standard may be described.

According to an embodiment, the following large-size RU aggregation may be used for MU transmission. The embodiment described below is an embodiment in the consideration of the primary ch20 (primary 20 MHz or P20). In this case, P20 may be assumed to be the lowest 20 MHz in terms of frequency. For example, it may be assumed that the first 20 MHz channel (ch1) within 80 MHz [ch1 ch2 ch3 ch4] is P20. For another example, the following patterns may be set differently according to the location of the primary channel.

1. Preamble Puncturing Pattern of 80 MHz Bandwidth

According to an embodiment, the preamble puncturing pattern of the 80 MHz bandwidth may be configured/set as shown in Table 14.

TABLE 14

| Aggregated EW | RU combination |
|---|---|
| 60 | 242 + 484; 484 + 242 |

2. Preamble Puncturing Pattern of 160 MHz Bandwidth

According to an embodiment, the preamble puncturing pattern of the 160 MHz bandwidth may be configured/set as shown in Table 15.

TABLE 15

| Aggregated BW | RU combination |
|---|---|
| 120 | 484 + 906, |

3. According to an embodiment, RU aggregation may be used for a bandwidth of 160 MHz or more (for example, 240/320 MHz). At this time, RU aggregation may be used for the limited cases as follows.

3-(1) 320 MHz Case

For example, large-size RU aggregation may be applied only within two 160 MHz (that is, primary 160 or secondary 160) included in 320 MHz.

3-(2) 240 MHz Case

For example, large-size RU aggregation may be applied only within one continuous 160 MHz or another 80 MHz included in 240 MHz.

4. In the EHT standard, subchannel selective transmission (SST) of the 11ax standard may be used/applied. For example, the STA may receive a signal by being used as an 80 MHz segment. That is, within 160 MHz, the STA can transmit and receive signals by moving to a secondary 80 channel other than the primary 80 channel. Accordingly, when BW>160 MHz, the STA can transmit and receive signals in the 80 MHz segment by parsing the STA in units of 80 MHz, by using the SST of the 11ax standard in units of 160 MHz.

For example, in the case of 320 MHz, the STA may be parsed as primary 80 (first 80 segment) or secondary 80 (secondary 80 segment) within primary 160. For another example, the STA may be parsed as a third 80 segment or a fourth 80 segment within the secondary 160. Accordingly, the STA may receive the pre-EHT part and may decode the pre-EHT part.

Signal Field Configuration

In consideration of the above-described large size of multiple RU aggregation constraints and the SST operation of the 11ax standard, the signal field may be configured as follows during signal transmission of the EHT standard.

According to an embodiment, the U-SIG may be configured in units of 80 MHz. In this case, the U-SIG may be configured to include different information per 80 MHz (for example, a puncturing pattern of 80 MHz). For example, at 160 MHz, U-SIG may include 80 MHz U-SIG1 and 80 MHz U-SIG2. U-SIG1 and U-SIG2 may include different information.

According to an embodiment, the EHT-SIG may be configured differently in units of 160 MHz. For example, within 160 MHz, two EHT-SIG content configured in 20 MHz may be configured by duplication. Therefore, for the case of 160 MHz or more, EHT-SIG may be composed of EHT-SIG 1 and EHT-SIG 2. In addition, EHT-SIG 1 and EHT-SIG 2 may be configured with two 20 MHz content channels, respectively.

1. 80 MHz Case

1-A. According to an embodiment, the U-SIG may be configured at 20 MHz, and may be duplicated and transmitted within 80 MHz. The U-SIG may include puncturing information for 80 MHz.

1-B. According to an embodiment, the EHT-SIG may be configured as an EHT-SIG content channel configured in 20 MHz within 80 MHz. The EHT-SIG may include two EHT-SIG content channels. The EHT-SIG content channel may be configured as follows.

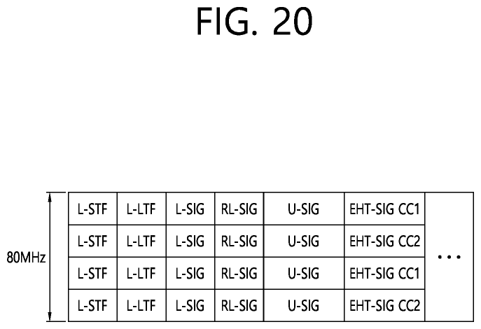

1-B-i. The EHT-SIG content channel may be composed of two within 80 MHz. Each content channel may include different information. The two content channels may be repeated within 80 MHz in units of 40 MHz and transmitted in the structure shown in FIG. 20.

FIG. 20 shows an example of a PPDU including an EHT-SIG.

Referring to FIG. 20, a PPDU (or EHT PPDU) may be configured at 160 MHz. EHT-SIG may include EHT-SIG CC1 (EHT-SIG content channel 1) and EHT-SIG CC2 (EHT-SIG content channel 2). EHT-SIG CC1 may be configured in 20 MHz, and may be configured repeatedly in units of 40 MHz. The EHT-SIG CC2 may also be configured at 20 MHz and may be configured repeatedly in units of 40 MHz.

1-B-ii. EHT-SIG CC1 may include information related to the first and third 20 MHz within 80 MHz. EHT-SIG CC2 may include information related to the 2nd and 4th 20 MHz.

1-B-iii. 20 MHz information included in the EHT-SIG CC (for example, EHT-SIG CC1 or EHT-SIG CC2) may include RU allocation information.

2. 160 MHz Case

2-A. According to an embodiment, unlike the above-described 80 MHz case, the U-SIG may be configured to include different information per 80 MHz. In this case, the U-SIG may include puncturing information for every 80 MHz (that is, 80 MHz segment). For example, a U-SIG (for example, U-SIG1 or U-SIG2) composed of different information per 80 MHz may be duplicated within 80 MHz in units of 20 MHz and transmitted.

2-B. According to an embodiment, similarly to the 80 MHz case described above, the EHT-SIG field may be configured with an EHT-SIG content channel configured with 20 MHz within 80 MHz. For example, two EHT-SIG content channels existing within 80 MHz may be repeated within 80 MHz in units of 40 MHz. In addition, the two EHT-SIG content channels may be repeatedly configured in units of 80 MHz within 160 MHz.

2-B-i. For example, EHT-SIG CC1 may include information related to the 1st, 3rd, 5th, and 7th 20 MHz within 160 MHz. EHT-SIG CC2 may include information related to the 2nd, 4th, 6th, and 8th 20 MHz.

2-B-ii. For example, 20 MHz information included in the EHT-SIG CC (for example, EHT-SIG CC1 or EHT-SIG CC2) may include RU allocation information.

2-B-iii. For example, each EHT-SIG content channel may be configured to include only information about 160 MHz including the corresponding channel (for example, RU allocation).

FIG. 21 shows an example of a PPDU including an EHT-SIG.

Referring to FIG. 21, a PPDU (or EHT PPDU) may be configured at 160 MHz. EHT-SIG may include EHT-SIG content channel 1 (EHT-SIG CC1) and EHT-SIG content channel 2 (EHT-SIG CC2). EHT-SIG CC1 may include information related to the 1st, 3rd, 5th, and 7th 20 MHz within 160 MHz. EHT-SIG CC2 may include information related to the 2nd, 4th, 6th, and 8th 20 MHz.

2-C. Unlike the above-described embodiment, since STAs may be allocated per 80 MHz segment, the EHT-SIG may be configured differently per 80 MHz.

2-C-i. In this case, the EHT-SIG content channel configured per 80 MHz may be configured to include information related to the 80 MHz or allocation information for 160 MHz including the 80 MHz.

2-C-i-a. For example, 484 RUs may be allocated to the primary 40 of the primary 80 (MHz), and the secondary 40 (484 RUs) of the primary 80 and the secondary 80 (996 RUs) may be aggregated and allocated.

In this case, the STA (the first STA) receiving an allocation of the primary 40 may be allocated to the primary 80 segment. The STA (the first STA) receiving an allocation of the primary 40 may decode the signal field in the primary 40.

The STA (second STA) to which the MRU is allocated may be allocated to the secondary 80 segment. The STA (second STA), to which the MRU is allocated, can decode the Signal Field at the corresponding 80 MHz.

In this case, EHT-SIG CC1 and CC2 present in the primary 80 may be configured to include both RU allocation information and MRU allocation information for primary 40 MHz. In addition, EHT-SIG CC1 and EHT-SIG CC2 of another 80 MHz segment (that is, secondary 80) may be configured to include only information related to MRU allocation.

In other words, EHT-SIG CC1 and EHT-SIG CC2 existing in another 80 MHz segment (that is, secondary 80) may include information different from EHT-SIG CC1 and CC2 existing in primary 80.

2-C-i-b. The above-described embodiment may be an example, and information related to 160 MHz allocation may be included in CC3 or CC4, and CC1 and CC2 may include information related to only allocated RUs.

2-C-i-c. As in the above-described embodiment, EHT-SIG CC1/CC2 and EHT-SUG CC3/CC4 of the 80 MHz segment may include only the RU allocation information for the corresponding 80 segment or may include information related to 80 segment that is different from allocation information of the corresponding 80 segment. Accordingly, the EHT-SIG may be configured differently per 80 MHz.

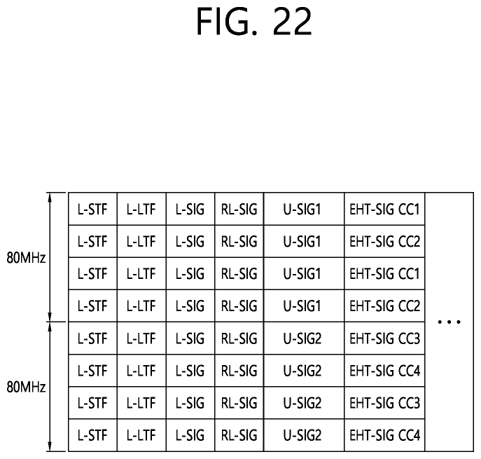

2-C-i-d. If the EHT-Sig Content channel is configured differently per 80 MHz, the PPDU containing the EHT-SIG may be configured as shown in FIG. 22

FIG. 22 shows an example of a PPDU including an EHT-SIG.

Referring to FIG. 22, the PPDU (or EHT PPDU) may be configured as 160 MHz. EHT-SIG may include EHT-SIG Content Channel 1 (EHT-SIG CC1), EHT-SIG Content Channel 2 (EHT-SIG CC2), EHT-SIG Content Channel 3 (EHT-SIG CC3), and EHT-SIG Content Channel 4 (EHT-SIG CC4). Within the first 80 MHz of 160 MHz, the EHT-SIG may be composed of EHT-SIG CC1 and EHT-SIG CC2. Within the second 80 MHz of 160 MHz, the EHT-SIG may be composed of EHT-SIG CC3 and EHT-SIG CC4.

3. 240 MHz Case

3-A. According to an embodiment, the U-SIG may be configured to include different information per 80 MHz. In this case, the U-SIG may include puncturing information for each 80 MHz (that is, 80 MHz segment). For example, U-SIGs (for example, U-SIG1, U-SIG2, and U-SIG3) configured with different information per 80 MHz may be duplicated within 80 MHz in units of 20 MHz and transmitted.

3-B. According to an embodiment, the EHT-SIG may be configured with continuous EHT-SIG1 for 160 MHz and EHT-SIG2 for 80 MHz except for this. At this time, EHT-SIG1 and EHT-SIG2 may be configured with different information.

3-B-i. For example, EHT-SIG1 may be configured as an EHT-SIG content channel configured in 20 MHz within 80 MHz, similar to the 160 MHz described above. Two EHT-SIG content channels existing within 80 MHz may be repeated within 80 MHz in units of 40 MHz. The two EHT-SIG content channels may be repeatedly configured in units of 80 MHz within 160 MHz.

EHT-SIG2 may be composed of an EHT-Sig Content Channel consisting of 20 MHz within 80 MHz, two EHT-Sig Content Channels in 80 MHz may be configured by repeatedly in a unit of 40 MHz within 80 MHz.

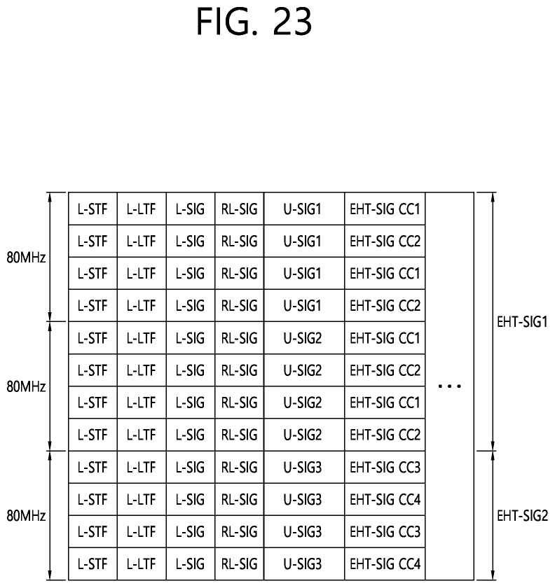

The PPDU including the above-described EHT-SIG may be configured as shown in FIG. 23.

FIG. 23 shows an example of a PPDU including an EHT-SIG.

Referring to FIG. 23, PPDU (or EHT PPDU) may be configured as 240 MHz. The EHT-SIG may be configured as EHT-SIG1 within 160 MHz and may be configured as EHT-SIG2 within the remaining 80 MHz. EHT-SIG1 may be composed of EHT-SIG Content Channel 1 (EHT-SIG CC1) and EHT-SIG Content Channel 2 (EHT-SIG CC2). EHT-SIG2 may be composed of EHT-SIG Content Channel 3 (EHT-SIG CC3) and EHT-SIG Content Channel 4 (EHT-SIG CC4).

3-B-i-a. EHT-SIG CC1 of EHT-SIG1 may include information related to the 1st, 3rd, 5th, and 7th 20 MHz within 160 MHz. EHT-SIG CC2 of EHT-SIG1 may include information related to the 2nd, 4th, 6th, and 8th 20 MHz.

3-B-i-b. EHT-SIG CC3 of EHT-SIG2 may include information related to the first and third 20 MHz within 80 MHz. EHT-SIG CC4 of EHT-SIG2 may include information about the 2nd and 4th 20 MHz.

3-B-i-c. For example, each EHT-SIG content channel may be configured to include only information about 160/80 MHz including the corresponding channel (for example, RU allocation).

3-B-i-d. For example, 20 MHz information included in the EHT SIG CC may include RU allocation information.

3-B-i-e. The above-described embodiment may be applied to both a case where 240 MHz is formed using 80 MHz puncturing for 320 MHz and a case where 240 MHz is used by forming channelization for 240 MHz.

3-C. Unlike the above-described embodiment, since STAs may be allocated per 80 MHz segment, the EHT-SIG may be configured differently per 80 MHz.

3-C-i. In this case, the EHT-SIG content channel configured per 80 MHz may include information related to the corresponding 80 MHz or allocation information for 80/160 MHz including the 80 MHz.

3-C-i-a. For example, 484 RUs may be allocated to a primary 40 of a primary 80 within a primary 160 (MHz), and a secondary 40 (484 RU) of the primary 80 and a secondary 80 (996 RU) may be aggregated and allocated.

In this case, the STA (the first STA) receiving an allocation of the primary 40 may be allocated to the primary 80 segment. The STA (the first STA) receiving an allocation of the primary 40 may decode the signal field in the primary 80.

The STA (second STA) receiving an allocation of the MRU may be allocated to the secondary 80 segment. The STA (second STA) receiving an allocation of the MRU may decode the Signal Field at the corresponding 80 MHz.

In this case, EHT-SIG CC1 and CC2 present in the primary 80 may be configured to include both RU allocation information and MRU allocation information for primary 40 MHz. In addition, EHT-SIG CC1 and EHT-SIG CC2 of another 80 MHz segment (that is, secondary 80) may be configured to include only information related to MRU allocation.

In other words, EHT-SIG CC1 and EHT-SIG CC2 existing in another 80 MHz segment (that is, secondary 80) may include information different from EHT-SIG CC1 and CC2 existing in primary 80.

3-C-i-b. The above-described embodiment is an example, and information related to 160 MHz allocation may be included in CC3 or CC4. CC1 and CC2 may include information related to only allocated RUs.

3-C-i-c. As in the above-described embodiment, EHT-SIG CC1/CC2 and EHT-SUG CC3/CC4 of the 80 MHz segment may be configured to include only RU allocation information for the corresponding 80 segment or may be configured to include allocation information of the corresponding 80 segment and information related to another 80 segment. Therefore, the EHT-SIG may be configured differently per 80 MHz.

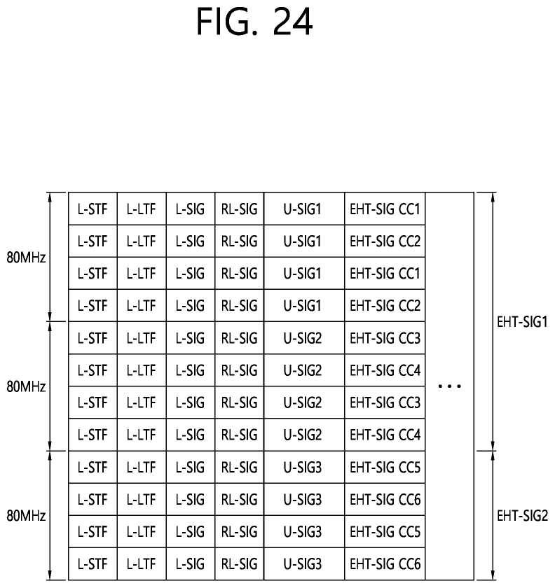

2-C-i-d. When the EHT-SIG content channel per 80 MHz is configured differently, the PPDU including the EHT-SIG may be configured as shown in FIG. 24.

FIG. 24 shows an example of a PPDU including an EHT-SIG.

Referring to FIG. 24, a PPDU (or EHT PPDU) may be configured at 240 MHz. The EHT-SIG may be configured as EHT-SIG1 within 160 MHz, and may be configured as EHT-SIG2 within the remaining 80 MHz. EHT-SIG1 may be composed of EHT-SIG CC1, EHT-SIG CC2, EHT-SIG CC3 and EHT-SIG CC4. EHT-SIG2 may consist of EHT-SIG CC5 and EHT-SIG CC6.

4. 320 MHz Case

4-A. According to an embodiment, the U-SIG may be configured to include different information per 80 MHz. In this case, the U-SIG may include puncturing information for each 80 MHz (that is, 80 MHz segment). For example, U-SIGs (for example, U-SIG1, U-SIG2, and U-SIG3) configured with different information per 80 MHz may be duplicated within 80 MHz in units of 20 MHz and transmitted.

4-B. According to an embodiment, the EHT-SIG may be configured with EHT-SIG1 for continuous 160 MHz and EHT-SIG2 for 160 MHz except for this. In this case, EHT-SIG1 and EHT-SIG2 may be configured to include different information.

4-B-i. EHT-SIG1 may be configured as an EHT-SIG content channel configured with 20 MHz within 80 MHz, similar to the 160 MHz case described above. Two EHT-SIG content channels existing in 80 MHz may be repeated in 80 MHz in units of 40 MHz and may be configured repeatedly in units of 80 MHz in 160 MHz.

EHT-SIG2 may also consist of an EHT-SIG content channel composed of 20 MHz within 160 MHz like EHT-SIG1. Two EHT-SIG content channels existing within 80 MHz may be configured to be repeated in units of 40 MHz within 80 MHz and may be configured to be repeated in units of 80 MHz again within 160 MHz.

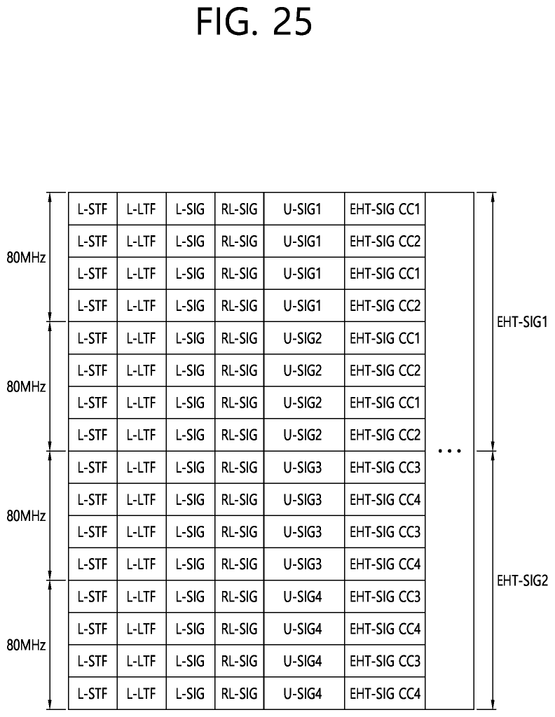

The PPDU including the above-described EHT-SIG may be configured as shown in FIG. 25.

FIG. 25 shows an example of a PPDU including an EHT-SIG.

Referring to FIG. 25, a PPDU (or EHT PPDU) may be configured at 320 MHz. The EHT-SIG may be configured as EHT-SIG1 within 160 MHz, and may be configured as EHT-SIG2 within the remaining 160 MHz. EHT-SIG1 may be composed of EHT-SIG CC1 and EHT-SIG CC2. EHT-SIG2 may be composed of EHT-SIG CC3 and EHT-SIG CC4.

4-B-i-a. EHT-SIG CC1 of EHT-SIG1 may include information related to 1st, 3rd, 5th, and 7th 20 MHz within 160 MHz (that is, a frequency range in which EHT-SIG1 is transmitted). EHT-SIG CC2 of EHT-SIG1 may include information related to the 2nd, 4th, 6th, and 8th 20 MHz.

4-B-i-b. EHT-SIG CC3 of EHT-SIG2 may include information related to 1st, 3rd, 5th, and 7th 20 MHz within 160 MHz (that is, a frequency range in which EHT-SIG2 is transmitted). EHT-SIG CC4 of EHT-SIG2 may include information related to the 2nd, 4th, 6th, and 8th 20 MHz.

4-B-i-c. For example, 20 MHz information included in the EHT SIG CC may include RU allocation information.

4-C. In the above-described example, the EHT-SIG content channel may be configured to include only information (e.g., RU allocation) about 160 MHz including the corresponding channel.

As in the above-described example, by configuring and transmitting the EHT-SIG differently in 160 MHz units, there is an effect that the overhead of the EHT-SIG can be reduced by half when MU is transmitted using a wide bandwidth. In addition, 80 MHz segment operation by SST defined in the 11ax standard can also be supported without additional signaling.

4-D. Unlike the above-described embodiment, since STAs may be allocated per 80 MHz segment, the EHT-SIG may be configured differently per 80 MHz.

4-D-i. In this case, the EHT-SIG content channel configured per 80 MHz may be configured to include information related to the corresponding 80 MHz or allocation information related to 160 MHz including the corresponding 80 MHz.

4-D-i-a. For example, 484 RUs may be allocated to a primary 40 of a primary 80 within a primary 160 (MHz), and a secondary 40 (484 RU) of the primary 80 and a secondary 80 (996 RU) may be aggregated and allocated.

In this case, the STA (the first STA) receiving an allocation of the primary 40 may be allocated to the primary 80 segment. The STA (the first STA) receiving an allocation of the primary 40 may decode the signal field in the primary 80.

The STA (second STA) receiving an allocation of the MRU may be allocated to the secondary 80 segment. The STA (second STA) receiving an allocation of the MRU may decode the Signal Field at the corresponding 80 MHz.

In this case, EHT-SIG CC1 and CC2 present in the primary 80 may be configured to include both RU allocation information and MRU allocation information for primary 40 MHz. In addition, EHT-SIG CC1 and EHT-SIG CC2 of another 80 MHz segment (that is, secondary 80) may be configured to include only information related to MRU allocation.

In other words, EHT-SIG CC1 and EHT-SIG CC2 existing in another 80 MHz segment (that is, secondary 80) may include information different from EHT-SIG CC1 and CC2 existing in primary 80. For example, EHT-SIG CC1 and EHT-SIG CC2 existing in another 80 MHz segment (that is, secondary 80) may be called EHT-SIG CC3 and EHT-SIG CC4 to distinguish them from EHT-SIG CC1 and CC2 existing in primary 80.

4-D-i-b. The above-described embodiment is an example, and information related to 160 MHz allocation may be included in CC3 or CC4. CC1 and CC2 may include information related to only allocated RUs.

4-D-i-c. As in the above-described embodiment, EHT-SIG CC1/CC2 and EHT-SUG CC3/CC4 of the 80 MHz segment may be configured to include only RU allocation information for the corresponding 80 segment or may be configured to include allocation information of the corresponding 80 segment and information related to another 80 segment. Therefore, the EHT-SIG may be configured differently per 80 MHz.

4-D-i-d. EHT-SIG CC5/CC6 and EHT-SIG CC7/CC8 may be configured to include different information within 160 MHz in the same manner as in the above-described example.

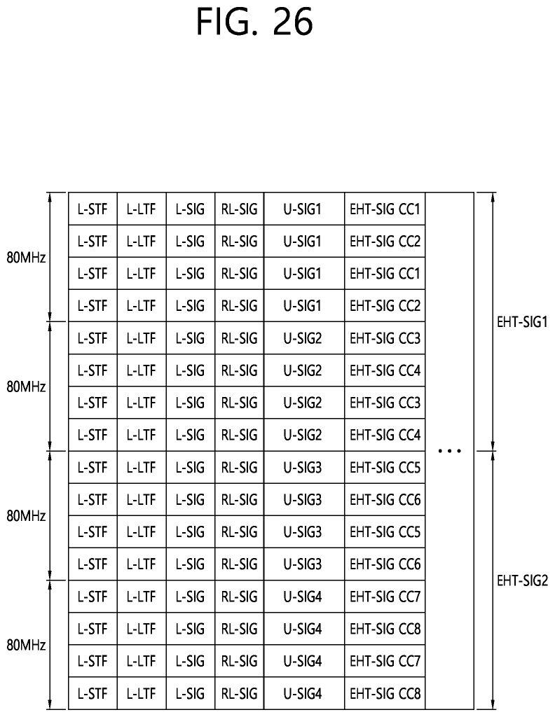

4-D-ii. When the EHT-SIG content channel per 80 MHz is configured differently, the PPDU including the EHT-SIG may be configured as shown in FIG. 26.

FIG. 26 shows an example of a PPDU including an EHT-SIG.

Referring to FIG. 26, a PPDU (or EHT PPDU) may be configured at 320 MHz. The EHT-SIG may be configured as EHT-SIG1 within 160 MHz, and may be configured as EHT-SIG2 within the remaining 160 MHz. EHT-SIG1 may consist of EHT-SIG CC1, EHT-SIG CC2, EHT-SIG CC3 and EHT-SIG CC4. EHT-SIG2 may consist of EHT-SIG CC5, EHT-SIG CC6, EHT-SIG CC7 and EHT-SIG CC8.

EHT-SIG1 may be configured differently in the EHT-SIG content channel per 80 MHz. Within the first 80 MHz, EHT-SIG1 may consist of EHT-SIG CC1 and EHT-SIG CC2. Within the second 80 MHz, EHT-SIG1 may consist of EHT-SIG CC3 and EHT-SIG CC4.

In EHT-SIG2, EHT-SIG content channels per 80 MHz may be configured differently. Within the first 80 MHz (that is, within the third 80 MHz of the full bandwidth) EHT-SIG2 may consist of EHT-SIG CC5 and EHT-SIG CC6. Within the second 80 MHz, EHT-SIG2 may consist of EHT-SIG CC7 and EHT-SIG CC8.

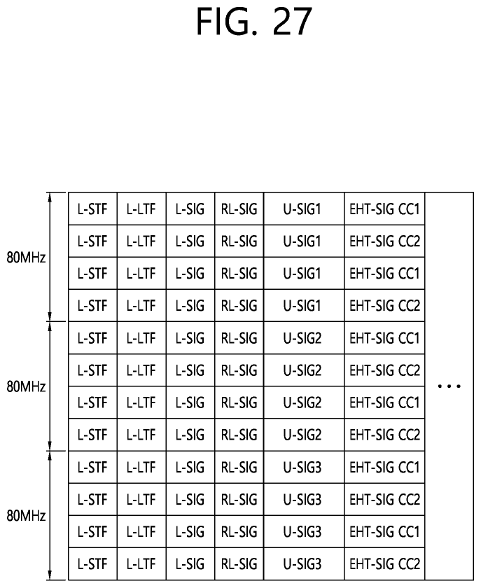

5. Unlike the above-described embodiment, large-size RU aggregation at 240 MHz may be applied within a continuous 160 MHz. Therefore, at continuous 240 MHz, MRU can be applied within 160 MHz consisting of (first 80 MHz and second 80 MHz) and (second 80 MHz and third 80 MHz). Therefore, when fixed channelization for 240 MHz is used, unlike 3-B, signaling complexity may be reduced and a new content channel may not be added. Therefore, the EHT-SIG content channel may be composed of two content channels in the same way as 160 MHz mentioned in case 2 above. The EHT-SIG content channel according to the above-described embodiment may be configured as shown in FIG. 27.

FIG. 27 shows an example of a PPDU including an EHT-SIG.

Referring to FIG. 27, a PPDU (or EHT PPDU) may be configured at 240 MHz. The EHT-SIG may include EHT-SIG CC1 and EHT-SIG CC2. EHT-SIG CC1 and EHT-SIG CC2 may be configured in units of 20 MHz, respectively, and may be configured to be duplicated in units of 40 MHz within the entire bandwidth (that is, 240 MHz).

Therefore, when BW<=240 and the MU-PPDU is transmitted, the EHT-SIG may be composed of two content channels (EHT-SIG CC1 and EHT-SIG CC2). In the case of 320 MHz, the EHT-SIG may be configured differently in 160 MHz units as suggested in 4 above. In addition, for each 160 MHz, the EHT-SIG may be configured and transmitted with two content channels (EHT-SIG CC1 and EHT-SIG CC2, EHT-SIG CC3 and EHT-SIG CC4), respectively.

6. In addition, as in the above-described embodiment, when the EHT-SIG is configured in units of 160 MHz, the indication for 3×996 may be performed through a subfield of the EHT-SIG CC in order to support 3×996 RU aggregation.

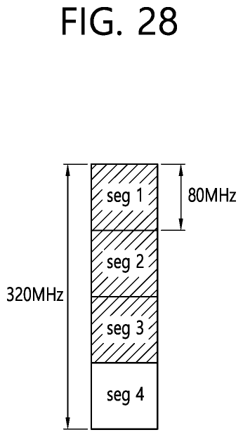

6-A. 3×996 RU aggregation at 320 MHz may be configured as shown in FIGS. 28 to 31.

FIGS. 28 to 31 show examples of 3×996 RU aggregation.

FIGS. 28 to 31, 3×996 RU aggregation may be configured by excluding 80 MHz from 320 MHz. 320 MHz may be composed of four segments (seg1 to seg4) composed of 80 MHz. Therefore, 3×996 RU aggregation may be configured by aggregating three segments among four segments.

6-B. The four cases of the above-described FIGS. 28 to 31 may be indicated based on 2-bit information in the common field of the EHT-SIG CC.

6-B-i. For example, 2-bit information may be defined as an additional 80 segment field. This is just one example and may be defined as another field.

6-B-ii. The additional 80 segment field may be defined as follows.

6-B-ii-a. 1. MSB among the 2 bits may be used to indicate whether additional 80 segments are allocated. Among the 2 bits, the LSB may be used to indicate the position of 80 segments within 160 MHz. Content indicated according to the 2-bit value may be configured as shown in Table 16.

TABLE 16

| Bits | Content |
|---|---|
| 00 | Not used (meaning that is not 3 × 996 RU aggregation) |
| 01 | Reserved |
| 10 | 3 × 996 RU aggregation |
| | Allocating Upper 80 segment |
| 11 | 3 × 996 RU aggregation |
| | Allocating Lower 80 segment |

Referring to Table 16, when the value of the additional 80 segment field is a first value (for example, 00), the additional 80 segment field may indicate that 3×996 RU aggregation is not used.

When the value of the additional 80 segment field is a second value (for example, 01), the additional 80 segment field may be used as reserved.

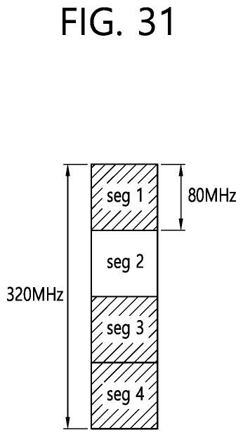

When the value of the additional 80 segment field is a third value (for example, 10), the additional 80 segment field may indicate that the upper 80 segment is allocated. In other words, the additional 80 segment field may indicate that 3×996 RU aggregation is configured as shown in FIGS. 28 and 31.

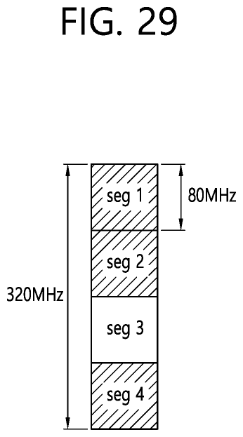

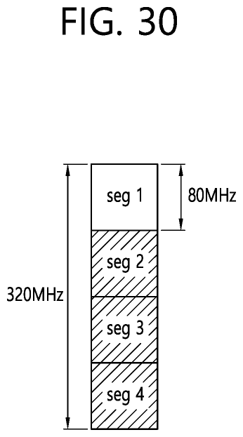

When the value of the additional 80 segment field is a fourth value (for example, 11), the additional 80 segment field may indicate that the lower 80 segment is allocated. In other words, the additional 80 segment field may indicate that 3×996 RU aggregation is configured as shown in FIGS. 29 and 30.

6-B-ii-b. For example, the additional 80 segment field may be set as follows to indicate each case according to the EHT-SIG content channel of each 160 MHz.

For example, when the MRU is used by aggregating the upper 80 MHz of the lower 160 MHz as shown in FIG. 28, the additional 80 segment field included in EHT-SIG CC1 and CC2 of the upper 160 MHz may be set to ‘10’ as shown in Table 16. In addition. EHT-SIG CC3 and CC4 of lower 160 MHz may be set to ‘00’.

As an example, EHT-SIG CC3 and CC4 may include RU allocation information for an 80 MHz segment allocated for MRU allocation. When information related to RU allocation is transmitted, by using empty allocation (242/484/996), RU allocation information for an 80 MHz segment allocated for MRU allocation may be indicated. In this case, the CC may be configured as a zero-user field.

For example, when an additional 80 segment field is used to indicate 3×996 RU, whether to allocate an 80 MHz segment included in another 160 MHz may be indicated. Accordingly, since MRU allocation can be informed without adding the RU allocation field to the content channel, there is an effect of reducing signaling overhead.

6-B-iii. Unlike the above-described embodiment, the additional 80 segment field may consist of 1 bit. In this case, in order to indicate that the 80 MHz segment is used for 3×996, an additional 80 segment field may be set to 1.

6-B-iii-a. The location of the 80 MHz segment may be indicated using the additional 80 segment field included for each CC. For example, the location of the 80 MHz segment indicated according to the value of the additional 80 segment field of the Content Channel may be set as shown in Table 17.

TABLE 17

| EHT-SIG | | |
|---|---|---|
| Content | additional | additional |
| Channel | 80 segment | 80 segment |
| number | field = 1 | field = 0 |
| 1 | 3^{rd} 80 MHz segment | Not |
| | allocated for 3 × 996 | |
| 2 | 4^{th} 80 MHz segment | Not |
| | allocated for 3 × 996 | |
| 3 | 1^{st} 80 MHz segment | Not |
| | allocated for 3 × 996 | |
| 4 | 2^{nd} 80 MHz segment | Not |
| | allocated for 3 × 996 | |

Referring to Table 17, when 3×996 is used using the third 80 mhz segment as shown in FIG. 28, an additional 80 segment field of EHT-SIG CC1 may be set to 1, and an additional 80 segment field of the remaining CCs may be set to 0. That is, when the additional 80 segment field of CC1 is set to 1 and the additional 80 segment field of CC2 to CC4 is set to 0, the STA may identify that the MRU configured as shown in FIG. 28 is used.

7. The EHT-SIG configuration and transmission method for MU transmission of the above-described embodiment may be equally applied to EHT-SU transmission. For example, when sending SU, EHT-SIG1 and EHT-SIG2 may be set to have the same value. Accordingly, EHT-SIG CC1 and EHT-SIG CC3 may be configured to have the same information. In addition, EHT-SIG CC2 and EHT-SIG CC4 may be configured to have the same information.

8. Unlike the above-described embodiment, the EHT-SIG may be configured differently according to the SU PPDU and the MU PPDU. For example, in the case of transmission of SU, EHT-SIG may be composed of 20 MHz EHT-SIG content channel and may be transmitted by duplication in transmission BW. For another example, in the case of MU-PPDU, the above-proposed method can be applied. That is, the EHT-SIG may be configured in units of 160 MHz. In this case, the EHT-SIG may be transmitted using two independent EHT-SIG content channels.

1, 2, 3, and 4 described below may mean independent 20 MHz content channels, respectively.

For example, during SU transmission at 240 MHz, the EHT-SIG may be configured as [1 1 1 1 1 1 1 1 1 1 1 1]. In other words, the EHT-SIG may be configured by repeating content channel 1.

For example, during MU transmission at 240 MHz, the EHT-SIG may be configured with two EHT-SIGs. The EHT-SIG may consist of EHT-SIG1 and EHT-SIG2. EHT-SIG1 and EHT-SIG2 may each consist of two content channels. Therefore, during MU transmission at 240 MHz, the EHT-SIG may be configured as [1 2 1 2 1 2 1 2 3 4 3 4]. That is, EHT-SIG1 may be configured with 160 MHz, and EHT-SIG1 may be configured with 80 MHz. EHT-SIG1 may be configured with two content channels (CC1 and CC2) within 160 MHz. EHT-SIG2 may be configured with two content channels (CC3 and CC4) within 80 MHz.

Hereinafter, operations of the transmitting STA and the receiving STA according to the above-described embodiments may be described.

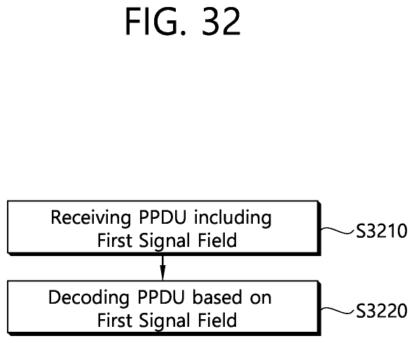

FIG. 32 is a flowchart illustrating an operation of a receiving STA.

Referring to FIG. 32, in step S3210, the receiving STA may receive a PPDU including a first signal field. For example, the first signal field may include EHT-SIG.

According to an embodiment, the first signal field may include a plurality of content channels. For example, the first signal field may be configured based on the first bandwidth. As an example, the first bandwidth may include 160 MHz. Accordingly, the first signal field may be configured based on 160 MHz.

For example, a first content channel and a second content channel among a plurality of content channels may be configured within a frequency range of the first bandwidth. Each of the first content channel and the second content channel may be configured based on the second bandwidth. As an example, the second bandwidth may include 20 MHz. Accordingly, each of the first content channel and the second content channel may be configured based on 20 MHz. In other words, the first content channel and the second content channel may be configured with 20 MHz, respectively.

For example, the first content channel and the second content channel may be repeated in units of a third bandwidth within a frequency region of the first bandwidth. As an example, the third bandwidth may include 40 MHz. Accordingly, the first content channel and the second content channel may be repeated in units of 40 MHz within a frequency range of 160 MHz.

The frequency range of the first bandwidth may be divided based on the second bandwidth. For example, a frequency range of 160 MHz may be divided based on 20 MHz. The 160 MHz frequency range may be divided into eight sections again. The first content channel and the second content channel may be transmitted through a frequency range of 160 MHz. The first content channel may be configured as 20 MHz. The second content channel may also be configured as 20 MHz.

Among the eight sections, a first content channel configured with 20 MHz may be configured in odd-numbered sections (1, 3, 5, and 7th sections). A second content channel configured with 20 MHz may be configured in even-numbered sections (2nd, 4th, 6th, and 8th sections) among eight sections. In other words, the first content channel may be configured to be repeated (or duplicated) in units of 40 MHz. The second content channel may also be configured to be repeated (or duplicated) in units of 40 MHz.

The first content channel may include information related to an odd-numbered section among frequency ranges of the first bandwidth divided based on the second bandwidth. The second content channel may include information related to an even-numbered section among the frequency ranges of the first bandwidth divided based on the second bandwidth.

For example, the first content channel and the second content channel may include information about resource unit (RU) allocation. For example, the first content channel may include information related to resource unit allocation of an odd-numbered section among frequency ranges of the first bandwidth divided based on the second bandwidth. The second content channel may include information related to resource unit allocation of an even-numbered section among the frequency ranges of the first bandwidth divided based on the second bandwidth.

According to an embodiment, the first signal field may include different information in units of the first bandwidth. For example, the first signal field may include different information in units of 160 MHz.

For example, the first signal field may be composed of a first subfield and a second subfield based on the first bandwidth. For example, the first signal field may be composed of a first subfield and a second subfield based on 160 MHz. The first subfield may include a first content channel and a second content channel. The second subfield may include a third content channel and a fourth content channel.

When the total bandwidth of the PPDU is 240 MHz, the first signal field may be composed of a first subfield transmitted through a 160 MHz bandwidth and a second subfield transmitted through an 80 MHz bandwidth. Accordingly, at 240 MHz, the first content channel and the second content channel may be configured repeatedly through the 160 MHz bandwidth, and the third content channel and the fourth content channel may be configured repeatedly through the 80 MHz bandwidth.

When the total bandwidth of the PPDU is 320 MHz, the first signal field may be composed of a first subfield transmitted through a 160 MHz bandwidth and a second subfield transmitted through a 160 MHz bandwidth. Accordingly, in 320 MHz, the first content channel and the second content channel may be configured repeatedly through the 160 MHz bandwidth, and the third content channel and the fourth content channel may be configured repeatedly through the 160 MHz bandwidth.

According to an embodiment, the PPDU may further include a second signal field. For example, the second signal field may include a U-SIG. For example, the second signal field may be configured based on the fourth bandwidth within the entire bandwidth of the PPDU. The second signal field may include different information in units of the fourth bandwidth.

The second signal field may be repeatedly configured in units of a second bandwidth within the fourth bandwidth. For example, the fourth bandwidth may include 80 MHz. Accordingly, the second signal field may include different information in units of 80 MHz, and may be configured to be repeated (or duplicated) in units of 20 MHz within 80 MHz.

In step S3210, the transmitting STA may decode the PPDU based on the first signal field.

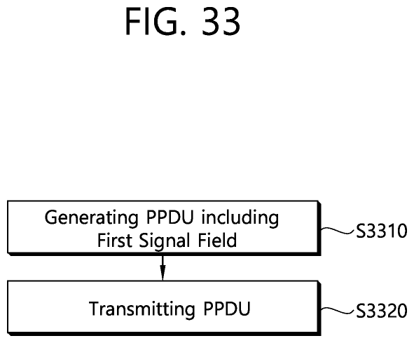

FIG. 33 is a flowchart illustrating an operation of a transmitting STA.

Referring to FIG. 33, in step S3310, the transmitting STA may generate a PPDU including the first signal field. For example, the first signal field may include EHT-SIG.

According to an embodiment, the first signal field may include a plurality of content channels. For example, the first signal field may be configured based on the first bandwidth. As an example, the first bandwidth may include 160 MHz. Accordingly, the first signal field may be configured based on 160 MHz.

For example, a first content channel and a second content channel among a plurality of content channels may be configured within a frequency range of the first bandwidth. Each of the first content channel and the second content channel may be configured based on the second bandwidth. As an example, the second bandwidth may include 20 MHz. Accordingly, each of the first content channel and the second content channel may be configured based on 20 MHz. In other words, the first content channel and the second content channel may be configured with 20 MHz, respectively.

For example, the first content channel and the second content channel may be repeated in units of a third bandwidth within a frequency region of the first bandwidth. As an example, the third bandwidth may include 40 MHz. Accordingly, the first content channel and the second content channel may be repeated in units of 40 MHz within a frequency range of 160 MHz.

The frequency range of the first bandwidth may be divided based on the second bandwidth. For example, a frequency range of 160 MHz may be divided based on 20 MHz. The 160 MHz frequency range may be divided into eight sections again. The first content channel and the second content channel may be transmitted through a frequency range of 160 MHz. The first content channel may be configured as 20 MHz. The second content channel may also be configured as 20 MHz.

Among the eight sections, a first content channel configured with 20 MHz may be configured in odd-numbered sections (1, 3, 5, and 7th sections). A second content channel configured with 20 MHz may be configured in even-numbered sections (2nd, 4th, 6th, and 8th sections) among eight sections. In other words, the first content channel may be configured to be repeated (or duplicated) in units of 40 MHz. The second content channel may also be configured to be repeated (or duplicated) in units of 40 MHz.

The first content channel may include information related to an odd-numbered section among frequency ranges of the first bandwidth divided based on the second bandwidth. The second content channel may include information related to an even-numbered section among the frequency ranges of the first bandwidth divided based on the second bandwidth.

For example, the first content channel and the second content channel may include information about resource unit (RU) allocation. For example, the first content channel may include information related to resource unit allocation of an odd-numbered section among frequency ranges of the first bandwidth divided based on the second bandwidth. The second content channel may include information related to resource unit allocation of an even-numbered section among the frequency ranges of the first bandwidth divided based on the second bandwidth.

According to an embodiment, the first signal field may include different information in units of the first bandwidth. For example, the first signal field may include different information in units of 160 MHz.

For example, the first signal field may be composed of a first subfield and a second subfield based on the first bandwidth. For example, the first signal field may be composed of a first subfield and a second subfield based on 160 MHz. The first subfield may include a first content channel and a second content channel. The second subfield may include a third content channel and a fourth content channel.

When the total bandwidth of the PPDU is 240 MHz, the first signal field may be composed of a first subfield transmitted through a 160 MHz bandwidth and a second subfield transmitted through an 80 MHz bandwidth. Accordingly, at 240 MHz, the first content channel and the second content channel may be configured repeatedly through the 160 MHz bandwidth, and the third content channel and the fourth content channel may be configured repeatedly through the 80 MHz bandwidth.

When the total bandwidth of the PPDU is 320 MHz, the first signal field may be composed of a first subfield transmitted through a 160 MHz bandwidth and a second subfield transmitted through a 160 MHz bandwidth. Accordingly, in 320 MHz, the first content channel and the second content channel may be configured repeatedly through the 160 MHz bandwidth, and the third content channel and the fourth content channel may be configured repeatedly through the 160 MHz bandwidth.

According to an embodiment, the PPDU may further include a second signal field. For example, the second signal field may include a U-SIG. For example, the second signal field may be configured based on the fourth bandwidth within the entire bandwidth of the PPDU. The second signal field may include different information in units of the fourth bandwidth.

The second signal field may be repeatedly configured in units of a second bandwidth within the fourth bandwidth. For example, the fourth bandwidth may include 80 MHz. Accordingly, the second signal field may include different information in units of 80 MHz, and may be configured to be repeated (or duplicated) in units of 20 MHz within 80 MHz.

In step S3320, the transmitting STA may transmit a PPDU. According to an embodiment, the transmitting STA may transmit a PPDU including the first signal field.

The technical features of the present disclosure described above may be applied to various devices and methods. For example, the above-described technical features of the present disclosure may be performed/supported through the apparatus of FIGS. 1 and/or 19. For example, the above-described technical features of the present disclosure may be applied only to a part of FIGS. 1 and/or 19. For example, the technical features of the present disclosure described above may be implemented based on the processing chips 114 and 124 of FIG. 1, may be implemented based on the processors 111 and 121 and the memories 112 and 122 of FIG. 1, or may be implemented based on the processor 610 and the memory 620 of FIG. 19. For example, the apparatus of the present disclosure includes a processor and a memory coupled to the processor. The processor may be adapted to receive a physical layer protocol data unit (PPDU) including a first signal field, wherein the first signal field includes a plurality of content channels, wherein the plurality of content channels are configured based on a first bandwidth, wherein a first content channel and a second content channel among the plurality of content channels are configured within a frequency range of the first bandwidth, wherein the first content channel and the second content channel are configured based on a second bandwidth, respectively, and wherein the first content channel and the second content channel are repeated in units of a third bandwidth within the frequency range of the first bandwidth; and decode the PPDU based on the first signal field.

The technical features of the present disclosure may be implemented based on a computer readable medium (CRM). For example, a CRM proposed by the present disclosure may store instructions which perform operations including the steps of receiving a physical layer protocol data unit (PPDU) including a first signal field, wherein the first signal field includes a plurality of content channels, wherein the plurality of content channels are configured based on a first bandwidth, wherein a first content channel and a second content channel among the plurality of content channels are configured within a frequency range of the first bandwidth, wherein the first content channel and the second content channel are configured based on a second bandwidth, respectively, and wherein the first content channel and the second content channel are repeated in units of a third bandwidth within the frequency range of the first bandwidth; and decoding the PPDU based on the first signal field. The instructions stored in the CRM of the present disclosure may be executed by at least one processor. At least one processor related to CRM in the present disclosure may be the processors 111 and 121 or the processing chips 114 and 124 of FIG. 1, or the processor 610 of FIG. 19. Meanwhile, the CRM of the present disclosure may be the memories 112 and 122 of FIG. 1, the memory 620 of FIG. 19, or a separate external memory/storage medium/disk.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method performed by a receiving station (STA) in a wireless local area network system, the method comprising:
receiving a physical layer protocol data unit (PPDU) including a first signal field,
wherein the first signal field includes a plurality of content channels,
wherein the plurality of content channels are configured based on a first bandwidth,
wherein a first content channel and a second content channel among the plurality of content channels are configured within a frequency range of the first bandwidth,
wherein the first content channel and the second content channel are configured based on a second bandwidth, respectively, and
wherein the first content channel and the second content channel are repeated in units of a third bandwidth within the frequency range of the first bandwidth; and
decoding the PPDU based on the first signal field.

2. The method of claim 1,
wherein the first signal field is composed of a first subfield and a second subfield based on the first bandwidth.

3. The method of claim 2,
wherein the first subfield includes the first content channel and the second content channel.

4. The method of claim 2,
wherein the second subfield includes a third content channel and a fourth content channel.

5. The method of claim 1,
wherein the frequency range of the first bandwidth is divided based on the second bandwidth,
wherein the first content channel includes information related to an odd-numbered range among the frequency range of the first bandwidth divided based on the second bandwidth, and
wherein the second content channel includes information related to an even-numbered range among the frequency range of the first bandwidth divided based on the second bandwidth.

6. The method of claim 1,
wherein the first content channel and the second content channel include information related to resource unit (RU) allocation.

7. The method of claim 1,
wherein the PPDU further includes a second signal field,
wherein the second signal field is configured based on a fourth bandwidth within an entire bandwidth of the PPDU, and
wherein the second signal field is repeatedly configured in units of the second bandwidth within the fourth bandwidth.

8. The method of claim 7,
wherein the first bandwidth includes 160 MHz,
wherein the second bandwidth includes 20 MHz,
wherein the third bandwidth includes 40 MHz, and
wherein the fourth bandwidth includes 80 MHz.

9. A method performed by a transmitting station (STA) in a wireless local area network system, the method comprising:
generating a physical layer protocol data unit (PPDU) including a first signal field,
wherein the first signal field includes a plurality of content channels,
wherein the plurality of content channels are configured based on a first bandwidth,
wherein a first content channel and a second content channel among the plurality of content channels are configured within a frequency range of the first bandwidth,
wherein the first content channel and the second content channel are configured based on a second bandwidth, respectively, and
wherein the first content channel and the second content channel are repeated in units of a third bandwidth within the frequency range of the first bandwidth; and
transmitting the PPDU.

10. A receiving station (STA) in a wireless local area network system, the receiving STA comprising:
a transceiver for transmitting and receiving a radio signal; and
a processor coupled to the transceiver, the processor is adapted to,
receive a physical layer protocol data unit (PPDU) including a first signal field,
wherein the first signal field includes a plurality of content channels,
wherein the plurality of content channels are configured based on a first bandwidth,
wherein a first content channel and a second content channel among the plurality of content channels are configured within a frequency range of the first bandwidth,
wherein the first content channel and the second content channel are configured based on a second bandwidth, respectively, and
wherein the first content channel and the second content channel are repeated in units of a third bandwidth within the frequency range of the first bandwidth; and
decode the PPDU based on the first signal field.

11. The receiving STA of claim 10,
wherein the first signal field is composed of a first subfield and a second subfield based on the first bandwidth.

12. The receiving STA of claim 11,
wherein the first subfield includes the first content channel and the second content channel.

13. The receiving STA of claim 11,
wherein the second subfield includes a third content channel and a fourth content channel.

14. The receiving STA of claim 10,
wherein the frequency range of the first bandwidth is divided based on the second bandwidth,
wherein the first content channel includes information related to an odd-numbered range among the frequency range of the first bandwidth divided based on the second bandwidth, and
wherein the second content channel includes information related to an even-numbered range among the frequency range of the first bandwidth divided based on the second bandwidth.

15. The receiving STA of claim 10,
wherein the first content channel and the second content channel include information related to resource unit (RU) allocation.

16. The receiving STA of claim 10,
wherein the PPDU further includes a second signal field,
wherein the second signal field is configured based on a fourth bandwidth within an entire bandwidth of the PPDU, and
wherein the second signal field is repeatedly configured in units of the second bandwidth within the fourth bandwidth.

17. The receiving STA of claim 16,
wherein the first bandwidth includes 160 MHz,
wherein the second bandwidth includes 20 MHz,
wherein the third bandwidth includes 40 MHz, and
wherein the fourth bandwidth includes 80 MHz.

18. (canceled)

19. (canceled)

20. (canceled)
